(19) United States
(12) Patent Application Publication
(10) Pub. No.: US 2021/0379783 A1
(43) Pub. Date: Dec. 9, 2021

(54) SLITTER DIRECTOR FOR AUTOMATED CONTROL OF SLIT ROLL GENERATION FROM MANUFACTURED WEB

(71) Applicant: 3M INNOVATIVE PROPERTIES COMPANY, St. Paul, MN (US)

(72) Inventors: Steven P. Floeder, Shoreview, MN (US); Steven R. Wageman, St. Paul, MN (US); Benjamin L. Brown, Oakdale, MN (US); Carl J. Skeps, Lakeville, MN (US); Matthew V. Rundquist, Woodbury, MN (US); Barbara E. Rokke, Maplewood, MN (US); David P. Bradbury, St. Paul, MN (US)

(21) Appl. No.: 17/283,604

(22) PCT Filed: Oct. 14, 2019
(86) PCT No.: PCT/IB2019/058746

§ 371 Date: Apr. 8, 2021

Related U.S. Application Data
(60) Provisional application No. 62/745,635, filed on Oct. 15, 2018.

(51) Int. Cl. B26D 1/14; G05B 19/406; B26D 5/00; B26D 5/32; B65H 26/02; B65H 35/02

(52) U.S. Cl. CPC B26D 1/141; G05B 19/406; B26D 5/007; B65H 2301/4148; B65H 26/02; B65H 35/02; G05B 2219/32222; B26D 5/32

(57) ABSTRACT

This disclosure describes techniques for automatically controlling the operation of a slitter (40) to convert a web (20) of material into smaller slit rolls (64, 66, 68). A slitter director (60) may automatically control the operation of a slitter (40) for defect removal, web splicing, and/or slit roll rejection based on continually registering previously-generated anomaly data (62) with physical locations of the web (20).

### BACKGROUND

Manufacturing processes for making various types of material (e.g., transparent polyester films), involve manufacturing the material in a long continuous sheet, referred to as a web. The web itself is generally a material having a fixed width in one direction (“crossweb direction”) and either a predetermined or indeterminate length in the orthogonal direction (“downweb direction”). During the various manufacturing processes used in making and handling the web, the web is conveyed along a longitudinal axis running in parallel to the length dimension of the web, and perpendicular to the width dimension of the web.

Inspection systems for the analysis of moving web materials can be important in the manufacture of paper, non-woven materials, and polymeric films, as well as metal fabrication. These inspection systems can be used for both product certification and online process monitoring. However, with webs of commercially viable width, the web speeds that are typically used, and the pixel resolution that is typically needed in these manufacturing operations, data acquisition speeds of tens or even hundreds of megabytes per second are required. It is a continual challenge to process images and to perform accurate defect detection at these data rates.

In general, each web roll is converted into products, referred to as sheet parts, by cutting the web roll into individual products. Optical film is one example of a manufactured web roll that is cut into various sheet parts for application to a wide variety of consumer products. In some applications, a web roll may be cut or “slit” into smaller rolls (e.g., smaller in both lengthwise and crosswise direction) prior to conversion into individual products. These smaller rolls may be called slit rolls. In some examples, slit rolls may be spliced to remove areas with defects prior to conversion. In other examples, individual slit rolls may be rejected to ensure quality. The splicing and rejections of slit rolls is typically performed using human inspectors who manually identify defective regions, stop the slitter at the appropriate locations of the defecting slit roll, and take proper action. Another typical application is to inspect the material on the slitter and have operators interact with the inspection system to remove the defective material.

### SUMMARY

In general, this application describes techniques for the automated processing of moving webs into slit rolls. More specifically, the techniques described herein may be used to automatically process a moving web into slit rolls using previously-generated anomaly data, taking into account the various products into which the web may be converted. For example, an anomaly may cause a defect in one product, yet be harmless in another product.

In one example, this disclosure describes a slitter director, which is an automated system that uses previously-generated anomaly data to automatically stop a slitter at locations deemed defective. The previously-generated anomaly data may have been generated by a manufacturing line that produces jumbo web rolls. The previously-generated anomaly data includes defect information that is registered to physical locations of the web. A slitter may continually register the previously-generated anomaly data with physical positions of the web rolls as the web rolls are being processed, thereby enabling automated control to stop the slitter at the precise location of rejectable defects so they can be removed. Quality data for the resultant slit rolls is accumulated and stored for later review or analysis.

In another example, the slitter director may be configured to use the previously-generated anomaly data to optimize slit roll selection and/or to identify rejectable slit rolls. For example, the slitter director may use the defect information in the previously-generated anomaly data to define the width of slit lanes that will produce the highest yield of output slit rolls (e.g., the fewest rejected slit rolls) given a particular product type that will be made from the output slit rolls. The slitter may then process the web into slit rolls based on the defined slit lane widths, and slit rolls identified as being rejectable may be discarded. In some examples, the slitter director may also be configured to automatically control the slitter to splice out areas of the web to remove defects. In other examples, the slitter director may not stop the slitter to splice out defects, but instead may run the slitter at full speed and discard entire slit rolls identified as rejectable.

Benefits of using the techniques of this disclosure may include more efficient operation of the slitter, more consistent outgoing quality, and more accurate storage and characterization of output slit rolls. For example, the techniques of this disclosure may provide for increased utilization, as a slitter may run faster through non-defective areas. As another example, the techniques of this disclosure may provide increased outgoing quality as defective areas are not missed by human operators. In addition, the techniques of this disclosure may allow for a decreased number of human inspectors on slitters. In addition, the techniques of this disclosure remove the need for human inspection on the slitter. This may be beneficial some applications because some materials have multiple layers and inspection of each layer may not be possible on the slitter (e.g., the top most layer may be opaque or have product-required markings).

In one example, this disclosure describes a method comprising obtaining previously-generated anomaly data that registers defects with physical locations of a web, continually registering the previously-generated anomaly data with the physical locations of the web to create registered anomaly data, automatically controlling a slitter to convert the web into a plurality of slit rolls in accordance with the registered anomaly data and a ruleset that specifies at least one condition indicating when the defects are to be removed from the web, and generating and storing registered anomaly data maps for each of the plurality of slit rolls.

In another example, this disclosure describes a system comprising a database configured to store previously-generated anomaly data that registers defects with physical locations of a web, a fiducial reader configured to read fiducial marks on the web, the fiducial marks indicating the physical locations of the web, a slitter configured to convert the web into a plurality of slit rolls, and at least one processor configured to control the operation of the slitter, the at least one processor configured to continually register the previously-generated anomaly data with the physical locations of the web to create registered anomaly data, automatically control the slitter to convert the web into the plurality of slit rolls in accordance with the registered anomaly data and a ruleset that specifies at least one condition indicating when the defects are to be removed from the web, and generate and store registered anomaly data maps for each of the plurality of slit rolls.

In another example, this disclosure describes a non-transitory computer-readable storage medium storing instructions that, when executed, cause at least one processor to obtain previously-generated anomaly data that registers defects with physical locations of a web, continually register the previously-generated anomaly data with the physical locations of the web to create registered anomaly data, automatically control a slitter to convert the web into a plurality of slit rolls in accordance with the registered anomaly data and a ruleset that specifies at least one condition indicating when the defects are to be removed from the web, and generating and storing registered anomaly data maps for each of the plurality of slit rolls.

In another example, this disclosure describes a method comprising obtaining previously-generated anomaly data that registers defects with physical locations of a web, determining at least one slit lane width based on the previously-generated anomaly data, and automatically controlling a slitter to convert the web into a plurality of slit rolls in accordance with the determined at least one slit lane width.

In another example, this disclosure describes a system comprising a database configured to store previously-generated anomaly data that registers defects with physical locations of a web, a slitter configured to convert the web into a plurality of slit rolls, and at least one processor configured to control the operation of a slitter, the at least one processor configured to obtain the previously-generated anomaly data associated with a web, determine at least one slit lane width based on the previously-generated anomaly data, and automatically control the slitter to convert the web into a plurality of slit rolls in accordance with the determined at least one slit lane width.

In another example, this disclosure describes a non-transitory computer-readable storage medium storing instructions that, when executed, cause at least one processor to obtain previously-generated anomaly data that registers defects with physical locations of a web, determine at least one slit lane width based on the previously-generated anomaly data, and automatically control a slitter to convert the web into a plurality of slit rolls in accordance with the determined at least one slit lane width.

In another example, this disclosure describes a method comprising obtaining previously-generated anomaly data that registers defects with physical locations of a web, and identifying at least one defective slit roll from a plurality or slit rolls that are processed from the web based on the previously-generated anomaly data.

In another example, this disclosure describes a system comprising a database configured to store previously-generated anomaly data that registers defects with physical locations of a web, a slitter configured to convert the web into a plurality of slit rolls, and at least one processor configured to identify at least one defective slit roll from a plurality or slit rolls that are processed from the web based on the previously-generated anomaly data.

In another example, this disclosure describes a non-transitory computer-readable storage medium storing instructions that, when executed, cause at least one processor to obtain previously-generated anomaly data that registers defects with physical locations of a web, and identify at least one defective slit roll from a plurality or slit rolls that are processed from the web based on the previously-generated anomaly data.

The details of one or more embodiments of the invention are set forth in the accompanying drawings and the description below. Other features, objects, and advantages of the invention will be apparent from the description and drawings, and from the claims.

### Definitions

For purposes of the present invention, the following terms used in this application are defined as follows:

“web” means a sheet of material having a fixed dimension in one direction and either a predetermined or indeterminate length in the orthogonal direction;

“web roll” means a roll of web material;

“slit roll” means a roll of web material cut from a web roll;

“defect” means an undesirable occurrence in a product;

“anomaly” or “anomalies” mean a physical deviation of the web from normal product that may or may not be a defect, depending on its characteristics and severity;

“register” means to match physical locations on a web roll or slit roll to data indicating anomalies on the web roll or slit roll;

“fiducial mark” means a barcode or other marking that indicates the physical position of a web roll or slit roll;

“application-specific” means defining requirements, e.g., grade levels, based on the intended use for the web;

“products” are the end products that incorporate individual sheets (also referred to as components) produced from a web, e.g., a rectangular sheet of film for a cell phone display or a television screen; and

“conversion” is the process of physically cutting individual sheets or slit rolls from a web that may be subsequently assembled into products.

### BRIEF DESCRIPTION OF DRAWINGS

FIG. 1 is a block diagram illustrating a global network environment of the manufacturing and conversion of web material.

FIG. 2 is a block diagram illustrating one process line in an example of a web manufacturing line.

FIG. 3 is a block diagram illustrating a slitter in accordance with one example of the disclosure.

FIG. 4 is a block diagram illustrating an example slitter controller in more detail.

FIG. 5 is a flowchart illustrating an example operation of a slitter in accordance with one example of the disclosure.

FIG. 6 is a conceptual diagram showing an example user interface for loading input rolls.

FIG. 7 is a conceptual diagram showing an example user interface for identifying input rolls.

FIG. 8 is a conceptual diagram showing an example user interface for setting quality parameters.

FIG. 9 is a conceptual diagram showing an example user interface for defining slit lanes.

FIG. 10 is a conceptual diagram showing an example user interface for previewing splices.

FIG. 11 is a conceptual diagram showing an example user interface for running a slitter.

FIG. 12 is a conceptual diagram showing another example user interface for running a slitter.

FIG. 13 is a conceptual diagram showing an example user interface for entering manual splices.

FIG. 14 is a conceptual diagram showing an example user interface for outputting the slit rolls.

FIG. 15 is a conceptual diagram showing an example user interface for unloading the input roll.

FIG. 16 is a conceptual diagram showing an example user interface for configuring rulesets.

FIG. 17 is a flowchart illustrating an example operation of a slitter director in accordance with one example of the disclosure.

### DETAILED DESCRIPTION

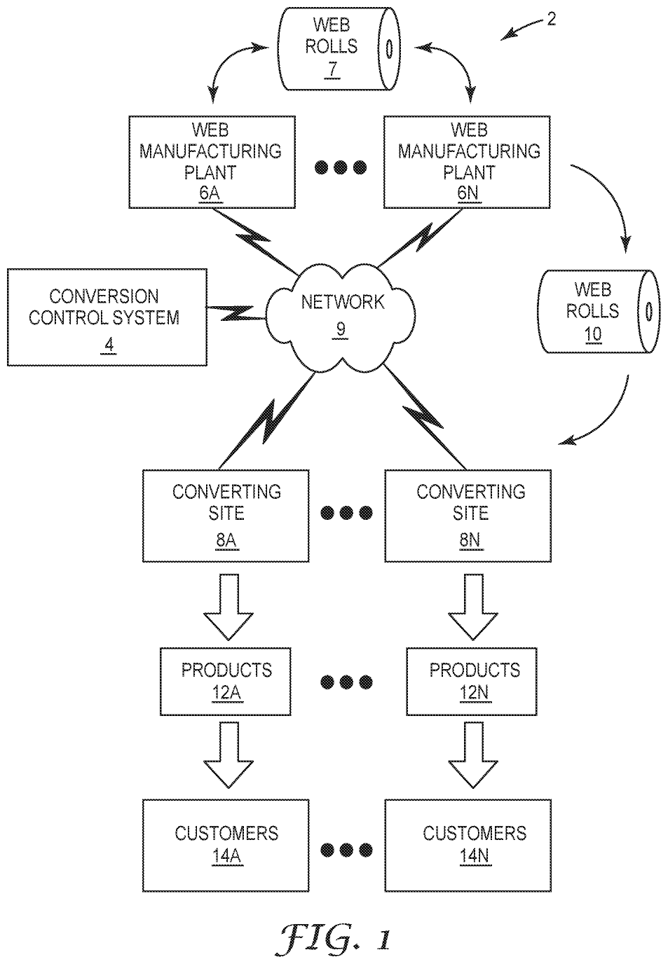

FIG. 1 is a block diagram illustrating global network environment 2 in which conversion control system 4 controls conversion of web material. In this example, web manufacturing plants 6A-6N (web manufacturing plants 6) represent manufacturing sites that produce and ship web material in the form of web rolls 7 between each other and ship finished web rolls 10 to converting sites 8A-8N (converting sites 8). Web manufacturing plants 6 may be geographically distributed, and each of the web manufacturing plants may include at least one manufacturing process line. Converting sites 8 may be part of the same entity as web manufacturing plants 6 and collocated therewith. In other examples, converting sites 8 are consumers of finished web rolls 10. Converting sites 8 may obtain finished web rolls 10 from web manufacturing plants 6 and convert finished web rolls 10 into individual sheets for incorporation into products 12 based on grade levels. In some examples, the selection process of which sheets should be incorporated into which of products 12 may be based on which of the grade levels each sheet satisfies. In some examples, converting sites 8 may include slitters which convert web rolls 10 into smaller slit rolls prior to conversion of the slit rolls into individual sheet parts. In accordance with the techniques described herein, converting sites 8 may also receive data previously-generated by web manufacturing plants 6, where the data defines regarding anomalies (i.e., potential defects) at specific locations of finished web rolls 10. Ultimately, converting sites 8 may convert finished web rolls 10 into individual sheets and/or slit rolls, which may be incorporated into products 12 for sale to customers 14A-14N (customers 14).

In general, web rolls 7 and 10 may contain manufactured web material that may be any web-like material having a fixed dimension in one direction and either a predetermined or indeterminate length in the orthogonal direction. Examples of web materials include metals, paper, wovens, non-wovens, glass, polymeric films, flexible circuits, or combinations thereof. Metals may include such materials as steel or aluminum. Wovens generally include various fabrics. Non-wovens include materials (e.g., paper, filter media, or insulating material). Films include, for example, clear and opaque polymeric films including laminates and coated films.

To produce a finished web roll 10 that is ready for conversion into individual sheets and/or slit rolls for incorporation into products 12, unfinished web rolls 7 may need to undergo processing from multiple process lines either within one web manufacturing plant, for instance, web manufacturing plant 6A, or within multiple manufacturing plants. For each process, a web roll is typically used as a source roll from which the web is fed into the manufacturing process. After each process, the web is typically collected again into a web roll 7 and moved to a different product line or shipped to a different manufacturing plant, where it is then unrolled, processed, and again collected into a roll. This process is repeated until ultimately a finished web roll 10 is produced.

For many applications, the web materials for each of web rolls 7 may have numerous coatings applied at least one production line of at least one web manufacturing plant 6. The coating is generally applied to an exposed surface of either a base web material, in the case of the first manufacturing process, or a previously applied coating in the case of a subsequent manufacturing process. Examples of coatings include adhesives, hardcoats, low adhesion backside coatings, metalized coatings, neutral density coatings, electrically conductive or nonconductive coatings, or combinations thereof. A given coating may be applied to only a portion of the web material or may fully cover the exposed surface of the web material. Further, the web materials may be patterned or unpatterned.

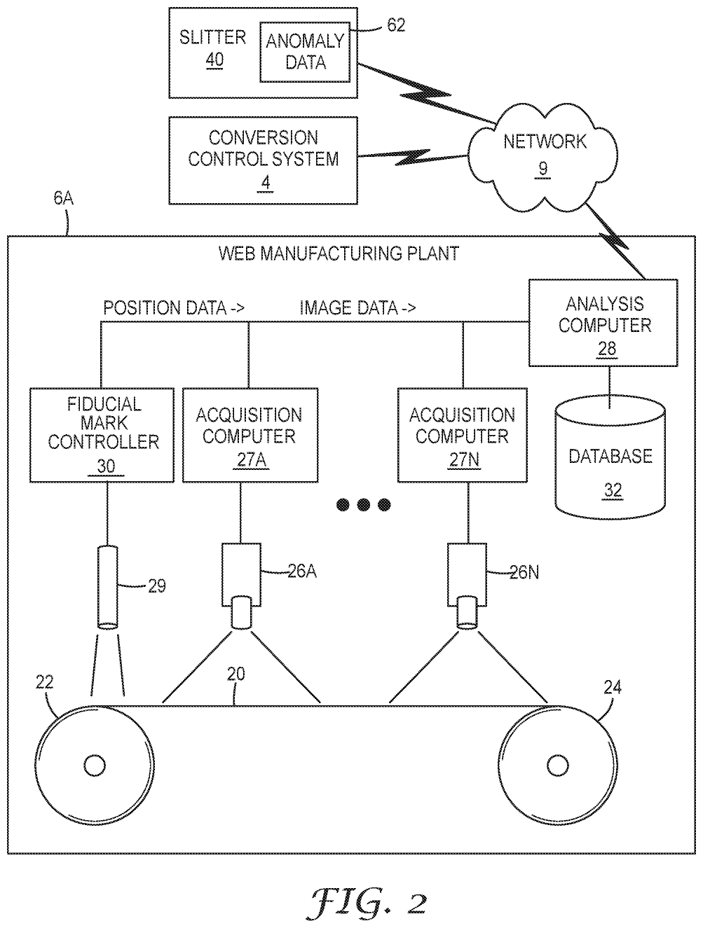

During each manufacturing process for a given one of web rolls 7, at least one inspection system acquires anomaly data for the web. For example, as illustrated in FIG. 2, an inspection system for a production line may include at least one image acquisition device positioned in close proximity to the continuously moving web as the web is processed (e.g., as at least one coating is applied to the web). The image acquisition devices scan sequential portions of the continuously moving web to obtain digital image data. The inspection systems may analyze the image data with at least one algorithm to produce so called “local” anomaly information. The anomaly information may include a plurality of anomaly objects or defects that are registered to physical locations of the web and define a plurality of characteristics for the physical deviations of the web at the corresponding area. An anomaly object may define characteristics (e.g., a deviation in width of the anomalous area of the web or a deviation in length of an anomalous area of the web). Thus, the length and width may represent a physical deviation from predefined characteristics that define, for example, various grade levels. In one example, image data may be acquired and processed to identify anomalies and to form anomaly objects as data structures representing each anomaly. Information regarding the acquisition and registration of anomaly information is detailed in U.S. Pat. No. 8,175,739 (Floeder et al.), the entire contents of which are hereby incorporated by reference.

In general, conversion control system 4 applies at least one defect detection algorithm that may be application-specific (i.e., specific to products 12) to select and generate a conversion plan for each web roll 10. A certain anomaly may result in a defect in one product (e.g., product 12A), whereas the anomaly may not cause a defect in a different product (e.g., product 12B). Each conversion plan represents defined instructions for processing a corresponding finished web roll 10. In accordance with the techniques described herein, conversion control system 4 may communicate the anomaly data for web rolls 10 to the appropriate converting sites 8 for use in converting the web rolls into individual sheets for products 12 (e.g., via network 9). In other examples, anomaly data may be transferred using computer-readable media (e.g., floppy disks, CD-ROMs, flash memory, or other computer-readable media known in the art).

In general, this application describes techniques for the automated processing of moving webs (e.g., web rolls 10) into slit rolls. More specifically, the techniques described herein may be used to automatically process web rolls 10 into slit rolls using previously-generated anomaly data that registers defects to physical locations of a web, such as the anomaly information provided to conversion control system 10.

As will be described in more detail below, a slitter director may use previously-generated anomaly data to automatically control the processing or web rolls into slit rolls. In one example, the slitter director may stop a slitter at locations deemed defective. The slitter director may continually register the previously-generated anomaly data with physical positions of the web rolls, thereby enabling automated control to stop the slitter at the precise location of rejectable defects so they can be removed. Quality data for the resultant slit rolls is accumulated and stored for later review or analysis.

Benefits of using the techniques of this disclosure may include more efficient operation of the slitter, more consistent outgoing quality, and more accurate storage and characterization of output slit rolls. For example, the techniques of this disclosure may provide for increased utilization, as a slitter may run faster through non-defective areas. As another example, the techniques of this disclosure may provide increased outgoing quality as defective areas are not missed by human operators. In addition, the techniques of this disclosure may allow for fewer human inspectors on slitters.

FIG. 2 is a block diagram illustrating an exemplary embodiment of one process line in an exemplary embodiment of web manufacturing plant 6A of FIG. 1. In the example of FIG. 2, a segment of web 20 is positioned between two support rolls 22, 24. Image acquisition devices 26A-26N (image acquisition devices 26) are positioned near the continuously moving web 20. Image acquisition devices 26 scan sequential portions of the continuously moving web 20 to obtain image data. Image acquisition devices 26 may be linescan cameras, areascan cameras, or any other type of camera system that may be configured to detect defects in a web. In addition, FIG. 2 shows one example of a possible configuration of image acquisition device 26. More or fewer image acquisition devices may be used. For example, multiple image acquisition devices 26 may deliver data to a single acquisition computer 27. Acquisition computers 27 collect image data from image acquisition devices 26 and transmit the image data to analysis computer 28 for preliminary analysis.

Image acquisition devices 26 may be conventional imaging devices that can read a sequential portion of the moving web 20 and providing output in the form of a digital data stream. As shown in FIG. 2, imaging devices 26 may be cameras that directly provide a digital data stream or an analog camera with an additional analog to digital converter. Other sensors (e.g., laser scanners) may be utilized as the imaging acquisition device. A sequential portion of the web indicates that the data is acquired by a succession of single lines. Single lines comprise an area of the continuously moving web that maps to a single row of sensor elements or pixels. Examples of devices suitable for acquiring the image include linescan cameras such as those available under the trade designations “MODEL #LD21” from Perkin Elmer, Sunnyvale, Calif.; “PIRANHA” from Dalsa, Waterloo, Ontario, Canada; and “AVIIVA SC2 CL” from Atmel, San Jose, Calif.). Additional examples include laser scanners from Surface Inspection Systems GmbH, Munich, Germany, in conjunction with an analog to digital converter.

The image may be optionally acquired through the utilization of optic assemblies that assist in the procurement of the image. The assemblies may be either part of a camera or may be separate from the camera. Optic assemblies utilize reflected light, transmitted light, or transflected light during the imaging process. Reflected light, for example, is often suitable for the detection of defects caused by web surface deformations, such as surface scratches.

In some examples, fiducial mark controller 30 controls fiducial mark reader 29 to collect roll and position information from web 20. For example, fiducial mark controller 30 may include at least one photo-optic sensor for reading bar codes or other indicia from web 20. In addition, fiducial mark controller 30 may receive position signals from at least one high-precision encoder engaged with web 20 and/or rollers 22, 24. Based on the position signals, fiducial mark controller 30 determines position information for each detected fiducial mark. For example, fiducial mark controller 30 may produce position information locating each detected fiducial mark within a coordinate system applied to the process line. In another example, analysis computer 28 may place each of the detected fiducial marks within the coordinate system based on the position data received from fiducial mark controller 30. In this case, the position data provided by fiducial mark controller 30 may represent distances between each fiducial mark in a dimension along the length of web 20. In either case, fiducial mark controller 30 communicates the roll and position information to analysis computer 28. Although discussed with respect to fiducial marks and a fiducial mark controller 30 and reader 29, fiducial marks may not be necessary in all examples to affect the techniques described herein.

Analysis computer 28 processes image streams from acquisition computers 27. Analysis computer 28 processes the digital information with at least one initial algorithm to generate local anomaly information that identifies any regions of web 20 containing anomalies that may ultimately qualify as defects. Analysis computer 28 may use one algorithm for each of the products 12 into which individual sheets may be incorporated. That is, analysis computer 28 may include a different application-specific defect detection algorithm for each of products 12. Analysis computer 28 may also include a different algorithm for each grade level. Analysis computer 28 may use each algorithm to determine whether an anomaly object represents a defect for each grade level. For each identified anomaly, analysis computer 28 extracts from the image data an anomaly image that contains pixel data encompassing the anomaly and possibly a surrounding portion of web 20. In some examples, analysis computer 28 may classify an anomaly into different defect classes. For instance, there may be unique defect classes to distinguish between spots, scratches, and oil drips. Other classes may distinguish between further types of defects. Analysis computer 28 may further determine in which of products 12 an anomaly may cause a defect. An example technique for analyzing image data to determine the presence and severity of anomalies is discussed in U.S. Pat. No. 7,027,934 (Skeps et al.), the entire contents of which are hereby incorporated by reference.

In one example, analysis computer 28 may determine that an anomaly is a defect when the intensity of the anomaly and the size of the anomaly exceed certain thresholds. A first algorithm for a first-grade level may determine that an anomaly is a defect when the intensity exceeds a measured value of 50 and the size of the anomaly (determined in pixels) is greater than 10 pixels. A second algorithm for a second-grade level may determine that an anomaly is a defect when the intensity exceeds a measured value of 190 and the size of the anomaly is greater than 2 pixels. A third algorithm for a third-grade level may determine that an anomaly is a defect when the intensity exceeds a measured value of 30 and the size of the anomaly exceeds 15 pixels. Thus, for a first example anomaly that has an intensity of 200 and a pixel size of 12, an analysis computer 28 running the exemplary algorithms would determine that the first anomaly is a defect for both the first-grade level and a second-grade level, but not for the third-grade level. As described in greater detail below, the analysis computer 28 may instruct at least one marker to mark this first anomaly with both the mark associated with the first-grade level and the mark associated with the second-grade level. Examples of algorithms are given in Table 1, below.

TABLE 1

| Algorithm | Intensity | Size (pixels) |
|---|---|---|
| A | 50 | 10 |
| B | 190 | 2 |
| C | 30 | 15 |

Examples of defects detected by the algorithms are given in Table 2, below.

TABLE 2

| Anomaly | Intensity | Size (pixels) | Defect In: |
|---|---|---|---|
| 17862 | 200 | 12 | A, B |
| 17863 | 100 | 5 | None |
| 17864 | 45 | 17 | C |
| 17865 | 70 | 11 | A |
| 17866 | 195 | 4 | B |
| 17867 | 198 | 16 | A, B, C |

Based on the position data produced by fiducial mark controller 30, analysis computer 28 determines the spatial position of each anomaly within the coordinate system of the process line. That is, based on the position data from fiducial mark controller 30, analysis computer 28 registers the x, y, and possibly z position for each anomaly with physical locations of the web given the coordinate system used by the current process line. For example, a coordinate system may be defined such that the x dimension represents a distance across web 20, ay dimension represents a distance along a length of the web, and the z dimension represents a height of the web, which may be based on the number of coatings, materials or other layers previously applied to the web. Moreover, an origin for the x, y, z coordinate system may be defined at a physical location within the process line and is typically associated with an initial feed placement of the web 20.

In any case, analysis computer 28 records in database 32 the spatial location of each anomaly with respect to the coordinate system of the process line, this information being referred to herein as local anomaly information. That is, analysis computer 28 stores the local anomaly information for web 20, including roll information for the web 20 and position information for each anomaly, within database 32. Analysis computer 28 may also record, for each anomaly, those portions of products 12 for which the anomaly may cause a defect. Database 32 may be implemented in any of several different forms including a data storage file or at least one database management system (DBMS) executing on at least one database server. The database management systems may be, for example, a relational (RDBMS), hierarchical (HDBMS), multidimensional (MDBMS), object oriented (ODBMS or OODBMS) or object relational (ORDBMS) database management system. As one example, database 32 is implemented as a relational database obtained under the trade designation “SQL SERVER” from Microsoft Corporation, Redmond, Wash.

Once the process has ended, analysis computer 28 may transmit the data collected in database 32 to conversion control system 4 and/or to slitter 40 via network 9. In accordance with examples of this disclosure, analysis computer 28 communicates the roll information as well as the local anomaly information (i.e., previously-generated anomaly data 62) to slitter 40 for subsequent, analysis and use. In one example of the disclosure, slitter 40 is a completely separate manufacturing line from web manufacturing plant 6A. That is, slitter 40 is physically separate from a web manufacturing line and the output web 20 is physically transported to slitter 40 for conversion into slit rolls. In another example, slitter 40 is part of the same web manufacturing plant 6A and web manufacturing line that produces output web 40. That is, slitter 40 may be part of an in-line web manufacturing and slitting line. In this example, because slitter 40 may perform a slit roll conversion process on output web 20 much faster than web manufacturing plant 6A may produce web 20, an accumulator (not shown) may be positioned between slitter 40 and web manufacturing plant 6A. The accumulator may wind an amount of output web 20 before beginning any slitting process on slitter 40 to account for the difference in processing speeds.

In one example, previously-generated anomaly data 62 may be communicated to slitter 40 by way of a database synchronization between database 32 and slitter 40. In other examples, previously-generated anomaly data 62 may be communicated to slitter 40 through network 9, using wireless or wired communication techniques. In other examples, previously-generated anomaly data 62 may be transferred to slitter 40 using computer-readable media (e.g., floppy disks, CD-ROMs, flash memory, or other computer-readable media known in the art). In other examples, slitter 40 (or another device such as a database) may be configured to combine anomaly data from at least one manufacturing line to create the previously-generated anomaly data 62.

As will be explained in more detail below, in accordance with the techniques of this disclosure, a slitter director as described herein may be configured to obtain previously-generated anomaly data 62 that spatially registers defects with physical locations of web 20, continually register previously-generated anomaly data 62 with the physical locations of web 20 to create registered anomaly data, and automatically control slitter 40 to convert web 20 into a plurality of slit rolls in accordance with the registered anomaly data and a ruleset that specifies at least one condition indicating when the defects are to be removed from web 20. The slitter director may be further configured to generate and store registered anomaly data maps for each of the plurality of slit rolls.

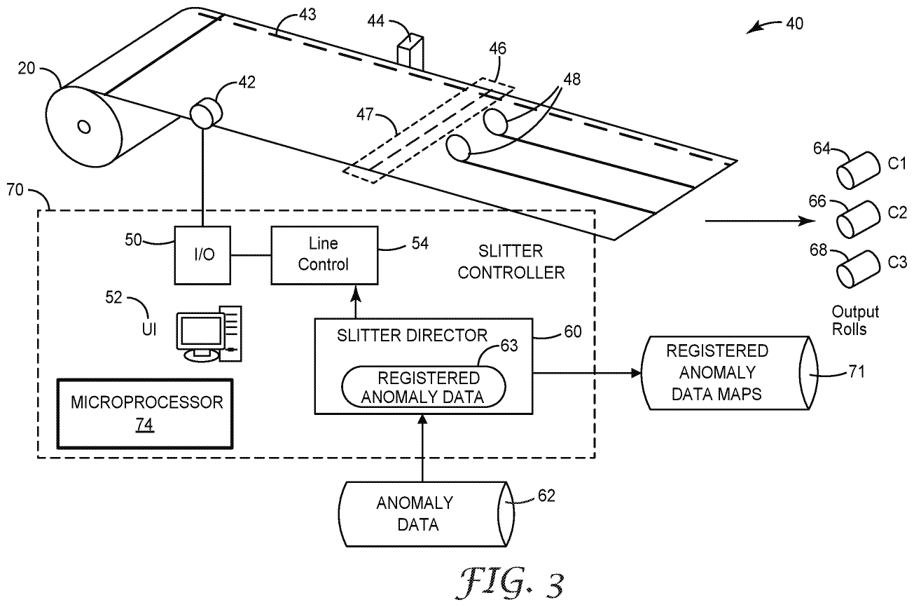

FIG. 3 is a block diagram illustrating an example of slitter 40 that is configured to convert a web roll into a plurality of slit rolls in accordance with the techniques of this disclosure. Slitter 40 may be configured to accept web roll 20 as an input and create a plurality of output slit rolls (e.g., slit roll 64, slit roll 66, and slit roll 68). The example of FIG. 3 shows three output slit rolls. However, more or fewer slit rolls may be converted from web roll 20 depending on the type of web material and the application desired.

Slitter 40 may include encoder 42, fiducial reader 44, splice station 46 and slitting knives 48. The operation of the various components of slitter 40 may be controlled by slitter controller 70. Slitter controller 70 may be configured to communicate with encoder 42 through I/O ports 50. Encoder 42 may be configured to measure the downweb position (e.g., the physical location) of web 20 as the web is being converted into slit rolls by slitter 40. Encoder 42 may also be configured to measure the speed at which slitter 40 is processing web roll 20, including a fast speed, a slow speed, or stopped (e.g., for defect removal and splicing).

Fiducial reader 44 may be configured to read fiducial marks 43 that are marked on web 20. Fiducial marks 43 indicate the physical position of the web relative to a coordinate system used by slitter 40. Fiducial reader 44 may include at least one photo-optic sensor for reading fiducial marks 43 (e.g., bar codes or other indicia) from web 20. Slitter controller 70 may receive position information from fiducial reader 44 through I/O 50. In some aspects, fiducial reader 44 may be used to confirm that physical position of the web measured by encoder 42. In some example, slitter 40 may not use a fiducial reader. In some examples, fiducial reader 44 and encoder 42 may be positioned after splice station 46.

Based on the position signals from either fiducial reader 44 and/or encoder 42, slitter controller 70 may determine position information for web 20. Slitter controller 70, through execution of slitter director 60, may place each of the detected fiducial marks within the coordinate system based on the position data received from fiducial reader 44 and/or encoder 42. In this case, the position data provided by fiducial reader 44 and/or encoder 42 may represent distances between each fiducial mark in a dimension along the length of web 20.

Slitter 40 may also include splice station 46. Splice station 46 is configured to remove a defective area of web 20 across the width of web 20. As shown in FIG. 3, splice station 46 may be configured to cut out and remove defective area 47 of web 20. Splice station 46 may then splice together the cut ends of web 20 and resume processing. Typically, slitter 40 is stopped to perform a splicing operation. That is, web 20 is stopped from moving through slitter 40. Slitter 40 may restart the movement of web 20 after the removal of defective area 47 is completed and web 20 is spliced together.

Slitting knives 48 are configured to cut web 20 into the plurality of output slit rolls (e.g., output slit rolls 64, 66, 68). Slitter 40 is shown as having two slitting knives 48 to produce three output slit rolls. More or fewer slitting knives may be used depending on the number and width of output slit rolls that is desired. Slitting knives 48 may be configurable to produce slit rolls of varying widths. The output width of a slit roll may define a slitting lane. Each slitting lane of slitter 40 may be configurable in width. In addition, not all slitting lanes of slitter 40 need be identical. Slitting lane widths may be independently configurable.

Slitter controller 70 may include at least one programmable microprocessor 74, at least one input/output (I/O) port 50, user interface 52 (e.g., a computer display), line control unit 54, and slitter director 60. In one example, slitter controller 70 may be a server-class computer and slitter director 60 may be software executable by microprocessor 74 of slitter controller 70 to control the operation of slitter 40.

User Interface (UI) 52 may include a display and at least one input device (e.g., a mouse, touchscreen, or keyboard). As will be explained in more detail below, UI 52 may provide information and control to a user of slitter controller 70 to verify, add, or change splices, configure rulesets for determining when to remove defects, set lane widths, display defect maps, control the speed of slitter 40, and display messages to the user.

I/O 50 receives and sends communications to and from slitter 40 and slitter controller 70. Slitter controller 70 may use line control 54 to change the speed of slitter 40, stop slitter 40, cause slitter 40 to remove defective areas of web 20, cause slitter 40 to splice web 20, and restart slitter 40. In general, line control 54 is configured to control the operation of slitter 40.

Slitter director 60 may be configured as software executable by microprocessor 74. Slitter 60 may be configured to automatically control the operation of slitter 40. For example, slitter 60 may be configured to automatically instruct line control 54 to control the operation of slitter 60. As will be explained in more detail below, slitter 60 may be configured to obtain previously-generated anomaly data 62. Previously-generated anomaly data 62 includes information that registers defects with physical locations of web 20. Slitter director 60 may cause slitter 40 (e.g., encoder 42 and/or fiducial reader 44) to continually register previously-generated anomaly data 62 with the physical locations of web 20 to create registered anomaly data 63. In this way, the accuracy of the physical locations registered in previously-generated anomaly data 62 is maintained while web 20 is being processed by slitter 40 (e.g., 10 mm downweb accuracy). By continually registering previously-generated anomaly data 62, slitter director 60 is able to maintain accuracy regardless of the number of times web 20 has been rewound. Slitter director 60 may be further configured to automatically control slitter 40 to convert web 20 into a plurality of slit rolls (e.g., output slit rolls 64, 66, and 68) in accordance with the registered anomaly data 63 and a ruleset that specifies at least one condition indicating when the defects are to be removed from web 20.

As one example, slitter director 60 may be configured to determine, from previously-generated anomaly data 62, specific regions or web 20 that are be removed from the output slit rolls to ensure quality. In this regard, slitter 60 may include a configurable ruleset that includes conditions and other converting rules that may be defined and updated by process or quality engineers. The ruleset may include conditions for defining what data in the previously-generated anomaly data 62 amounts to a defect for the specific web 20 being processed or the specific products that will be made from the output slit rolls.

As one example, the configurable ruleset may indicate that if one large coating void or three small black spots exist within any square meter of web 20, that portion of web 20 is to be removed. The size and types of defects in the ruleset may be configurable. Slitter director 60 may apply the conditions and converting rules of the ruleset to previously-generated anomaly data 62 to generate positions of web 20 that are to be removed and spliced. When registered anomaly data 63 satisfies a condition in the rule set, slitter director 60 may cause slitter 40 to stop, remove the defective area of web 20, splice web 20, and restart.

Slitter director 60 may be further configured to generate and store registered anomaly data maps 71 for each of the plurality of output slit rolls. Registered anomaly data maps 71 may include at least one of defect location from registered anomaly data 63, splice location, or change of the web roll. Slitter director 60 may associate portions of previously-generated anomaly data 62 that are present in each of the produced slit rolls, and include those portions of previously-generated anomaly data 62 in registered anomaly data maps 71 for each of slit rolls 64, 66, and 68. The registered anomaly data maps 71 may include defect information that is spatially registered to physical position of output slit rolls 64, 66, and 68, since registered anomaly data maps 71 are produced from previously-generated anomaly data 62 that is spatially registered to fiducial marks 43 of original web roll 20. Registered anomaly data maps 71 may also include data that indicates the downweb position of splices in the output slit rolls 64, 66, and 68. Registered anomaly data maps 71 may further include information indicating the source of the original input web roll 20 as well as links and/or pointers to previously-generated anomaly data 62 used by slitter director 60 to automatically process the input web rolls in the output slit rolls.

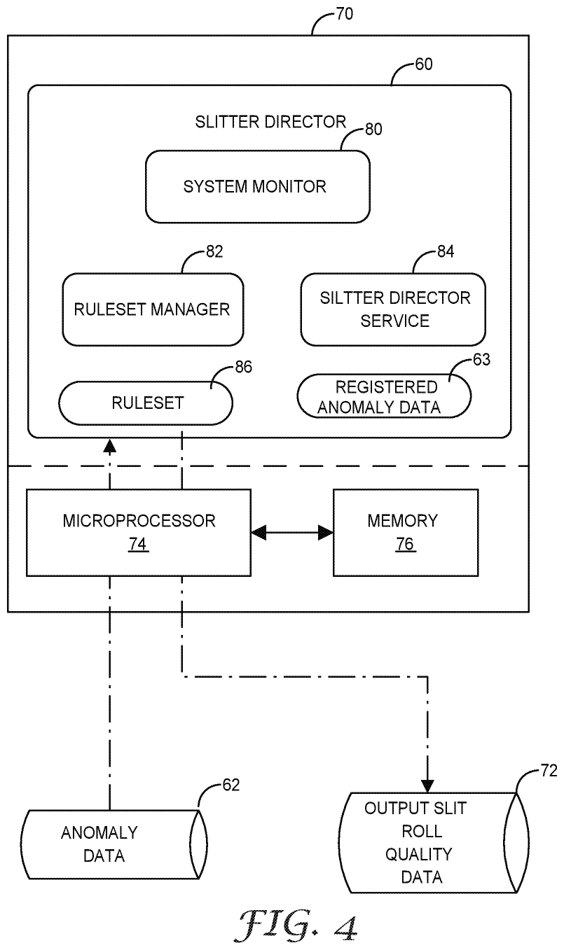

FIG. 4 is a block diagram illustrating an example slitter controller in more detail. As described above, slitter director 60 may be configured as software executable by microprocessor 74 of slitter controller 70. In some examples, slitter director 60 may be configured as a user-space application executable within an operating system of slitter 70. In other examples, slitter director 60 may be implemented in any combination of software, firmware, or hardware (e.g., an application-specific integrated circuit). Microprocessor 74 may store and access data associated with slitter director 60 from memory 76. In the example of FIG. 4, slitter controller 70 may be configured to access previously-generated anomaly data 62 from a database that is external to slitter controller 70. In other examples, previously-generated anomaly data 62 may be stored in memory 76.

In the example of FIG. 4, slitter director may include three main software modules: system monitor 80, ruleset manager 82, and slitter director service 84. System monitor 80 generates the main user interface for slitter director 60 (e.g., displayed by UI 52 of FIG. 3), that allows a user to select web rolls to be slit, select ruleset 86 to apply to the selected web roll, and control operation of slitter 40.

Ruleset manger 82 is configured to generate and/or modify rules and conditions of ruleset 86 for processing the web roll. In some examples, ruleset 86 may define conditions (e.g., 3 large or 7 medium defects in 1 lineal meter of web) that will cause slitter director 60 to cause slitter 40 to remove defective material from the web and splice web. In other examples, as will be explained in more detail below, ruleset 86 may include rules and conditions that specify slit lane widths, based on the previously-generated anomaly data 62, to maximize output slit roll yield given a particular product type that will be converted form the output slit rolls. Ruleset 86 may include also rules and conditions that indicate if a specific output roll is rejectable (e.g., contains more than a threshold number of defects, and thus may be discarded). Slitter director service 84 is a service that distributes commands between the UI (e.g., UI 52 of FIG. 3) and line control 54.

As described above, slitter director 40 may be configured to automatically convert web 20. In one aspect of the disclosure, slitter director 60 may be configured to identify a first set of anomalies in previously-generated anomaly data 62 that satisfies a configurable condition in ruleset 86. As will be shown below, system monitor 80 may be configured to display a map of the previously-generated anomaly data 62 to a user through UI 52.

As web 20 is being processed by slitter 40, slitter 60 continually registers previously-generated anomaly data 62 with physical locations of web 20 to create registered anomaly data 63. In this way, the physical locations of defects indicated in previously-generated anomaly data 62 may be accurately re-registered to the actual physical positions of web 20 as web 20 is being processed by slitter 40. Slitter director 60 may identify a first physical location of web 20 associated with the first set of anomalies in registered anomaly data 63. When the first physical location of web 20 approaches splice station 46, slitter director 60 may slow down and stop the slitter at the first physical location. Slitter director 60 may then cause slitter 50 to remove material from web 20 at the first physical location that contains the first set of anomalies and splice web 20. Slitter director 60 may then restart slitter 40.

System monitor 80 may be configured to display a map of the previously-generated anomaly data 62 to a user through UI 52. System monitor 80 may also be configured to display locations of splices that will occur based on ruleset 86. In this regard, system monitor 80 may also include inputs that allow a user to manually add a splice to web 20. Slitter director 60 may then automatically control slitter 40 to remove web material from web 20 at the locations of manually added splices. Likewise, system monitor 80 may also include inputs that allow a user to selectively disable or modify splices that are identified by slitter director 60. In other examples, system monitor 80 may also include inputs that allows a user combine two or more splices that are identified by slitter director 60. In the example above, a user may selectively disable removing material from web 20 at the first physical location that contains the first set of anomalies.

In some examples, ruleset manager 82 may be configured to determine ruleset 86 and the width of the slit lanes of slitter based on previously-generated anomaly data 62. For a given product or products that will be converted from the output slit rolls, ruleset manager 82 may be configured to determine rules and conditions in ruleset 86 that will result in a desired output quality of the slit rolls and/or a desired yield of converting web 20 into the output slit rolls. Slitter director 60 may also determine, given the product or products that will be converted from the output slit rolls, an optimal slit lane width given the defects present in the previously-generated anomaly data 62.

In other examples, ruleset manager 82 may be configured to display a user interface that allows a use to configure ruleset 82. A user may manually enter at least one condition for slitter director 60 to cause slitter 40 to automatically remove defective material from web 20. Ruleset manager 82 may be configured to allow a user to define conditions independent for each a plurality of slit lanes. That is, slitter director may make splicing decisions based on defect data in previously-generated anomaly data 62 for each of the slit lanes independently. In other examples, slitter director uses the same conditions in ruleset 86 for each of the slit lanes.

In either example, ruleset 86 may include at least one condition that determine whether or not slitter director 60 will direct slitter 40 to perform splices. In some examples, ruleset 86 may include a single condition that indicates whether or not slitter director 60 will cause slitter 40 to perform a splice. In other examples, ruleset 86 may include a combination of conditions that indicate whether or not slitter director 60 will cause slitter 40 to perform a splice. Such splicing conditions may be combined in any fashion using any logical operators.

In other examples of the disclosure, system monitor 80 may be configured to detect errors in the operation of slitter 40 and display messages indicating the errors to a user. Such system feedback may be given when slitter 40 does not stop in time to perform a splice, when slitter director 60 is not receiving any speed information from encoder 42, when fiducial reader 44 read fiducial marks in an unexpected order, or other malfunctions of slitter 40.

As discussed above, using data generated by encoder 42 and/or fiducial reader 44, slitter director 60 may continually register previously-generated anomaly data 62 with physical locations of web 20 to create registered anomaly data 63. In some examples, the coordinate system used in the creation of previously-generated anomaly data 62 may be different than a coordinate system used on slitter 40. In this example, slitter director 60 may be configured to align previously-generated anomaly data 62 to a coordinate system of slitter 40 to create aligned anomaly data and continually register the aligned anomaly data with physical locations of web 20 to create registered anomaly data 63. Slitter director 60 may be configured to perform such an alignment in the case that slitter director 60 determines that previously-generated anomaly data 62 is not aligned to the coordinate system of the slitter. In this regard, previously-generated anomaly data 62 may include information including the coordinate system used to create previously-generated anomaly data 62. Slitter director 60 may alter the orientation of previously-generated anomaly data 62 to create aligned anomaly data display the aligned anomaly data on UI 52.

In some examples, it may not be desirable to continually register previously-generated anomaly data 62. For example, some slitters may not have fiducial readers. In this example, slitter director 60 may have inputs for selectively disabling the continual registering of previously-generated anomaly data 62. In this example, slitter director 60 may provide an indication to a user (e.g., a user message on UI 52) of a physical location on web 20 on which defects are to be removed. For example, slitter director 60 may provide such an indication when web 20 is within a threshold distance of the physical locations containing the defects. A user may determine the physical location of web 20 based on a downweb position indicated by encoder 42. The user may then manually stop slitter 40 at the indicated position and manually cause slitter 40 to remove the defects and splice the web.

In another example of the disclosure, slitter director 60 may be configured to control the speed at which slitter 40 processes web 20 based on previously-generated anomaly data 62 and ruleset 86. In some examples, in order to continually register every fiducial mark 43 on web 20, slitter director 60 may cause slitter director 40 to run at less than a maximum speed. That is, fiducial reader 44 may not be able to read fiducial marks 43 when slitter 40 is operating at maximum speed.

As one example, slitter director 60 may be configured to slow down the operating speed of slitter 40 in order to register previously-generated anomaly data 62 with fiducial marks on web 20 when the position of web 20 is within a threshold distance of defects that are to be removed. Encoder 42 may provide a rough indication of the downweb position of web 20 while slitter 40 is running at a high speed (e.g., a speed higher than which fiducial reader 44 may read fiducial marks 43). Slitter director 60 may slow the speed of slitter 40 to a speed at which fiducial reader 44 may read fiducial marks 43 and provide a more accurate registration of previously-generated anomaly data 62. Once running at the slower speed, slitter director 60 may cause slitter 40 to remove defects and splice web 20 in the manner described above.

In general, slitter director 60 may be configured to run slitter 40 at a first speed (e.g., a higher speed than fiducial reader 44 may read fiducial marks 43) in the case that previously-generated anomaly data 62, in view of the conditions of ruleset 86, shows no rejectable defects within a predetermined distance to splice station 46 of slitter 40. The predetermined distance may be defined by ruleset 86. Slitter director 60 may further be configured to run slitter 40 at a second speed (e.g., a speed at which fiducial reader 44 may read fiducial marks 43) in the case that previously-generated 62 shows rejectable defects within the predetermined distance to splice station 46 of slitter 40. The second speed is slower than the first speed. Slitter director 60 may then continually register previously-generated anomaly data 62 with physical locations of web 20 to create registered anomaly data 63 only when slitter 40 is running at the second speed. In order to stop slitter 40 to remove possible defects, slitter director 60 may be configured to issue a slitter stop command at a configurable distance from splice station 46 of slitter 40. The configurable distance may be determined by taking into account the deceleration of slitter 40.

In other examples of the disclosure, slitter director 60 may be configured to optimize slit roll size and/or identify rejectable slit rolls using previously-generated anomaly data 62. Optimizing slit roll size and/or identifying rejectable slit rolls may be performed with or without any splicing of slit rolls. That is, slitter 40 may be configured to process web 20 continuously without stopping to remove any defects. After slitting has completed, a user may simply reject and discard a slit roll identified by slitter director 60 as being rejectable. In addition, optimizing slit roll size and/or identifying rejectable slit rolls may be used with or without any registering of the previously-generated anomaly data 62 with web 20.

In one example, slitter director 60 may obtain previously-generated anomaly data 62 and determine at least one slit lane width based on previously-generated anomaly data 62. Slitter director 60 may determine the slit lane widths based on where defects are physically located on web 20 as indicated by previously-generated anomaly data 62. Slitter director 60 may determine slit lane width so as to optimize the output yield of web 20. That is slitter director 60 may set the slit lane widths so the least amount of material is spliced. In another example, when splicing is not performed, slitter 60 may set the slit lane widths so that the fewest number of output slit rolls are rejected. As part of defining the slit lane widths, slitter director 60 may be further configured to identify at least one defective slit roll from the plurality or converted slit rolls based on previously-generated anomaly data 62. Slitter 60 may then automatically control slitter 40 to convert web 20 into a plurality of slit rolls in accordance with the determined at least one slit lane width.

In some examples, slitter 60 may use additional information to set the slit lane widths in order to optimize the yield of output slit rolls. For example, slitter 60 may additionally consider the output product type that may be converted from the output slit rolls to determine optimal slit lane widths. Additionally, or alternatively, slitter 60 may consider conditions in ruleset 86 to determine slit lane width. In this context, ruleset 86 may include conditions that specify a number and/or type of defects in an output slit roll that would render the output slit roll rejectable. Slitter director 60 may then determine slit roll widths that result in the fewest number of rejectable output slit rolls.

In other examples of the disclosure, slitter director 60 may be configured to identify which of the output slit rolls are rejectable and may be discarded based on previously-generated anomaly data 62. Identifying rejectable slit rolls may be useful in situations where stopping slitter 40 to perform splices is not preferred or in situations where the slit lane widths of slitter 40 are fixed. Slitter 60 may determine which output slit rolls are rejectable based on previously-generated anomaly data 62 and conditions specified in a ruleset. In this example, the ruleset may include at least one condition that specify how many defects (e.g., defects of a particular type(s)) are allowed in the output slit roll.

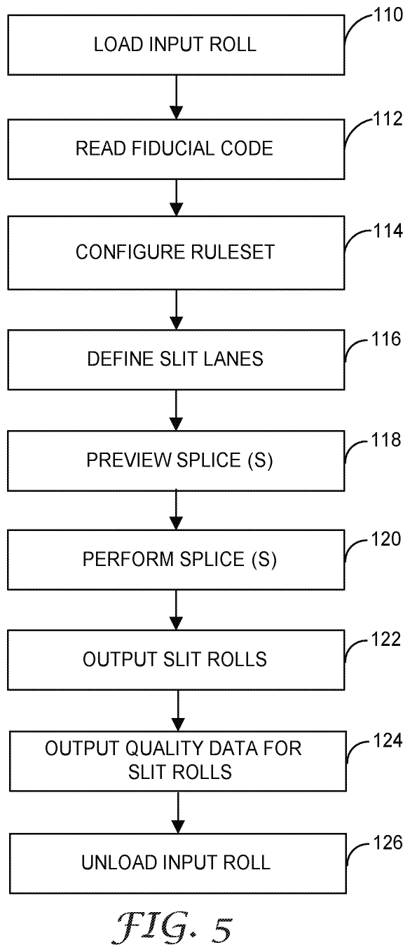

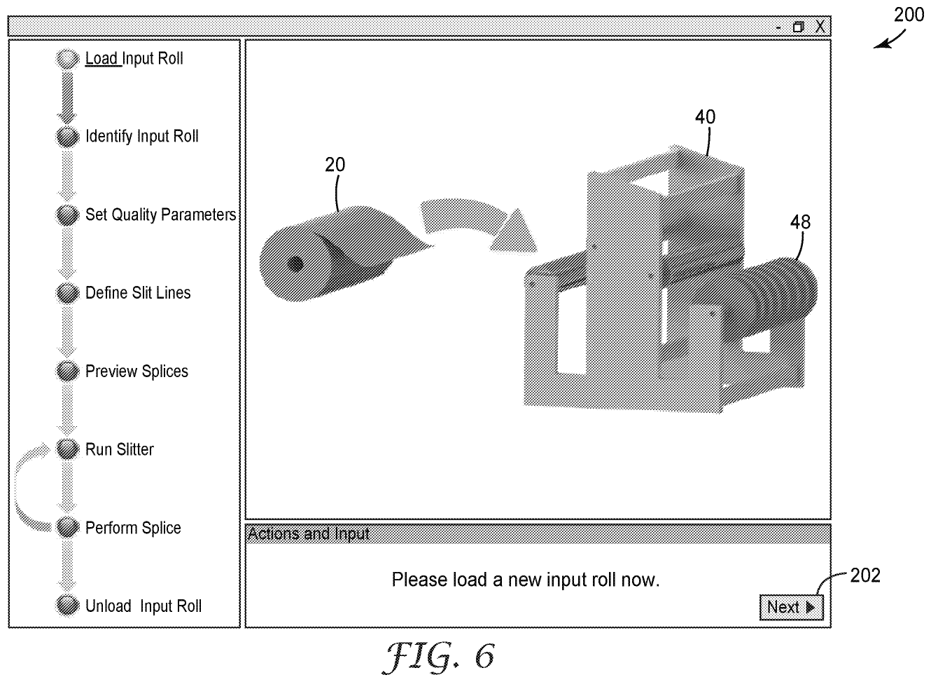

FIG. 5 is a flowchart illustrating an example operation of slitter 40 in accordance with one example of the disclosure. A user may load an input roll into a slitter (110). In addition, the user may open system monitor 80 to begin the operation of slitter director 60. FIG. 6 is a conceptual diagram showing an example user interface of system monitor 80 for loading input rolls. User interface 200 illustrates that input web roll 20 is to be loaded onto slitter 40. As part of the loading process, the user may lace input rolls to slitting knives 48 so that the input roll may be slit into output slit rolls. The user may then instruct system monitor 80 that the input roll has been loaded (e.g., by selecting next button 202).

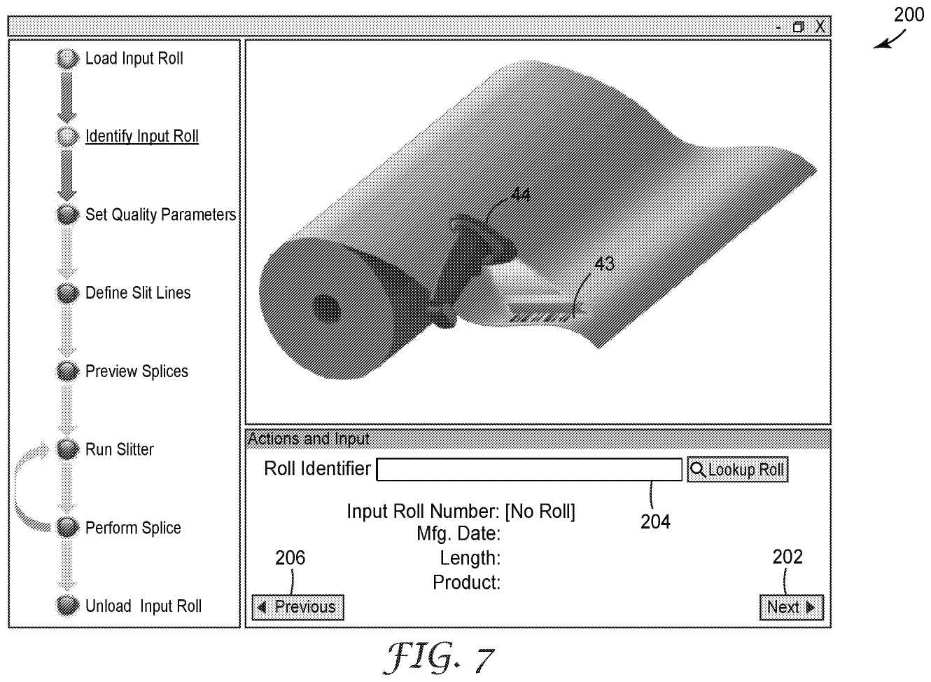

Returning to FIG. 5, slitter director 60 may then identify the input roll by reading fiducial code (112). Slitter director 60 may use the identified input roll to locate and obtain the associated previously-generated anomaly data 62. FIG. 7 is a conceptual diagram showing an example user interface of system monitor 80 for identifying input rolls. To read the fiducial code, slitter director 60 may cause fiducial reader 44 to scan the fiducial mark 43 nearest to and before fiducial reader 44. In some examples, a user may manually enter a roll identifier number in input box 204. For example, the roll identifier number may be a number associated with web roll 20 and/or digits of fiducial mark 43. Slitter director 60 may access a database to identify the roll associated with the entered fiducial mark. If the provided fiducial marks exists on numerous rolls, then slitter director 60 may display a dialog that prompts the user to select the correct roll.

The user may then instruct system monitor 80 that the input roll has been identified (e.g., by selecting next button 202). User interface 200 of system monitor 80 may further include “previous” button 206 that enables a user to return to any previous screen of user interface 200.

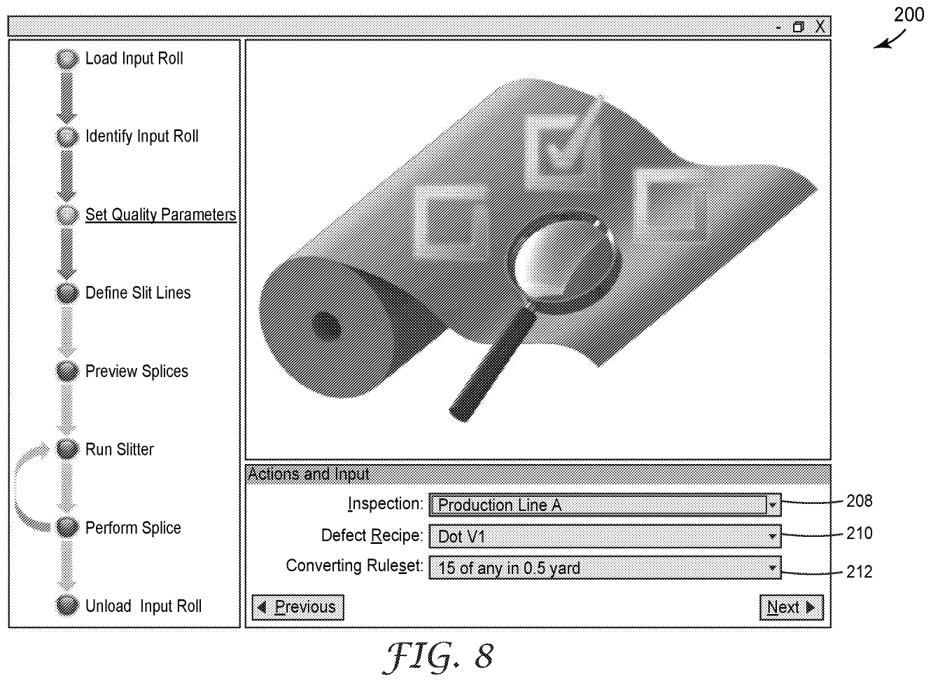

Returning to FIG. 5, slitter 60 may then allow the user to configure and/or select the ruleset (114) and set quality parameters. FIG. 8 is a conceptual diagram showing an example user interface of system monitor 80 for setting quality parameters. In some examples, slitter director 60 may retrieve previously-generated anomaly data 62 from a database based on the web roll identified above. In other examples, a user may manually enter information that cause slitter director 60 to obtain previously-generated anomaly data 62. As one example, a user may select inspection pull down 208 that list all inspection systems available. One option in the pulldown list is the Composite Recipe Resolver, which is the location to choose if the user wants to slit to a composite recipe (e.g., a combination of anomaly sets from multiple process steps). The Defect Recipe 210 is a list of all associated defect or composite recipes. Defect Recipe 210 can be the full set of anomaly data or some subset of anomaly data, as described in U.S. Pat. No. 8,935,104 (Floeder et al.). A user may also select a ruleset from converting ruleset pull down 212. Converting ruleset pull down 212 lists rulesets that are available for use. As will be explained in more details below, the user may configure rulesets using ruleset manager 82.

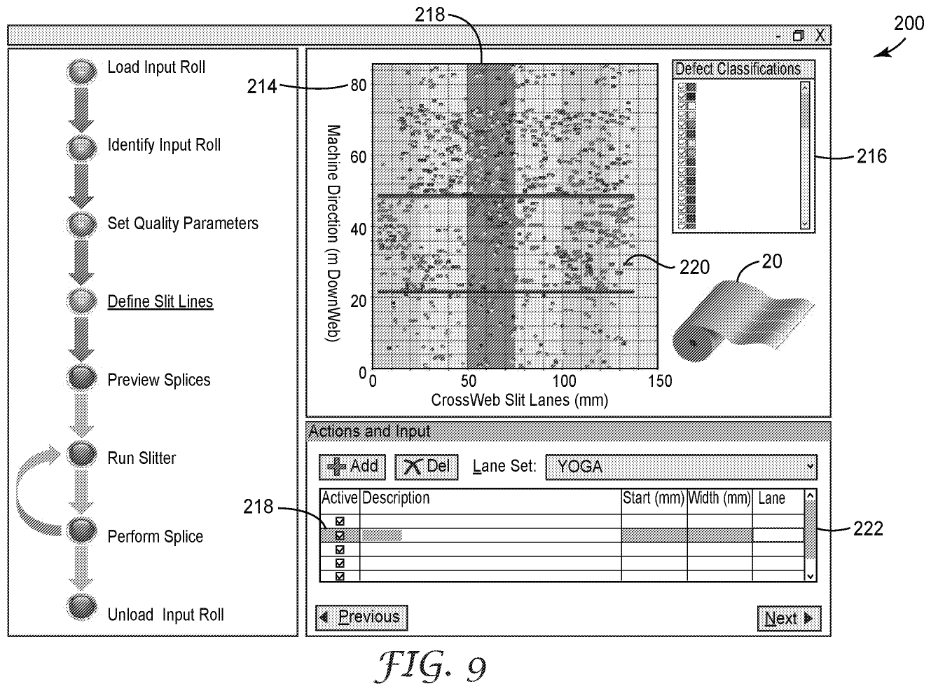

Returning to FIG. 5, slitter director 60 may then define slit lanes for converting the web into slit rolls (116). As described above, slitter director may define slit lane widths automatically based on previously-generated anomaly data 62 and/or ruleset 86. FIG. 9 is a conceptual diagram showing an example user interface of system monitor 80 for defining slit lanes. As shown in FIG. 9, during the define slit lanes process, user interface 200 may include defect map 214. Defect map 214 includes visual indications of where defects are physically located on web 20. Different classifications of defects may be visually represented using defect symbols 220 having different shapes, colors, and/or sizes to represent the different possible types of defects. User interface 200 may further include key 216 that indicates that classification of defect represented by each of defect symbols 220. Key 216 may include selectable buttons next to each of the types of defects in order to allow the user to turn on or off the display of certain classifications of defects on defect map 214. In some examples, only those defect classifications that are defined in the selected ruleset are displayed on defect map 214.

Defect map 214 may also visually represent slit lanes 218. User interface 200 may allow the user to select an already defined slit lane set. A user may then use slit lane definition input 22 to change the dimensions (e.g., slit lane width of the selected slit lane). In addition, slit lane definition input 22 may be configured to allow a user to manually define slit lanes. Slit lane definition input 22 may also be configured to allow a user to deselect a particular lane. This may be accomplished by unchecking the “Active” selection 224 on the selected lane. When deselected, slitter director 60 will not apply the selected ruleset to the deselected slit lane. In some examples, the deselection of a lane is not saved and will be automatically undone when the next input roll is loaded or when slitter director 60 is closed and relaunched. Deselecting slit lanes can be helpful when defect map 214 reveals that many of the splices are due to one slitting lane. Rather than making all the splices, which will affect all the slit rolls, it may be more economical to just set that lane as inactive and then throw away the entire slit roll. In some examples, based on the ruleset, slitter director 60 may be configured to automatically deselect a slit lane if that slit lane will cause more than a threshold number of splices.

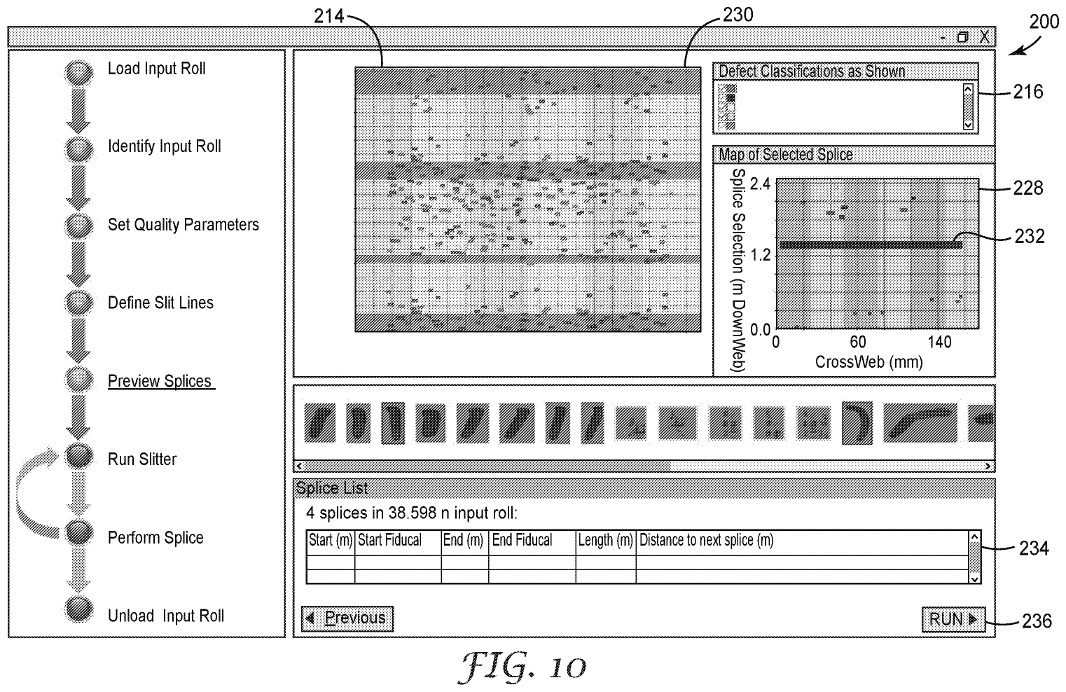

Returning to FIG. 5, slitter director 60 may then preview at least one splice to the user (118). As described above, slitter director 60 may be configured to determine physical locations of web 20 to remove defective material and perform splices based on previously-generated anomaly data 62 and ruleset 86. FIG. 10 is a conceptual diagram showing an example user interface of system monitor 80 for previewing splices. As shown in FIG. 10, when previewing splices, system monitor 80 may further display at least one recommend splice region 230 of web 20 for removal of defect material and splicing. System monitor 80 may further display a splice map 228 showing a selected splice 232 to be performed on web. System monitor may also display splice list 234 that includes all the splices recommended for web 20. The information in splice list 234 may include the physical location of the splice (e.g., the downweb position) as well as the length of the splice. A user may select any row in splice list 234 or may highlight any splice region 230 in defect map 230 to selected splice to be displayed in splice map 228. The user may also select any defect in defect map 214 to highlight the region containing the selected in splice map 228.

In some examples, slitter director 60 may be configured to determine, based on the ruleset, if a first recommended splice is less than a minimum distance to the splice station of slitter 40. In response, slitter 60 may display warning that indicates that a recommended splice is imminent, and that such splice is too close for slitter director 60 to synchronize and stop slitter 40. Slitter director may include information in the warning that indicates to the user the amount of bad material to manually remove. If the first recommend splice is not an imminent splice, then the user may select RUN button 236 to start the slitting process.

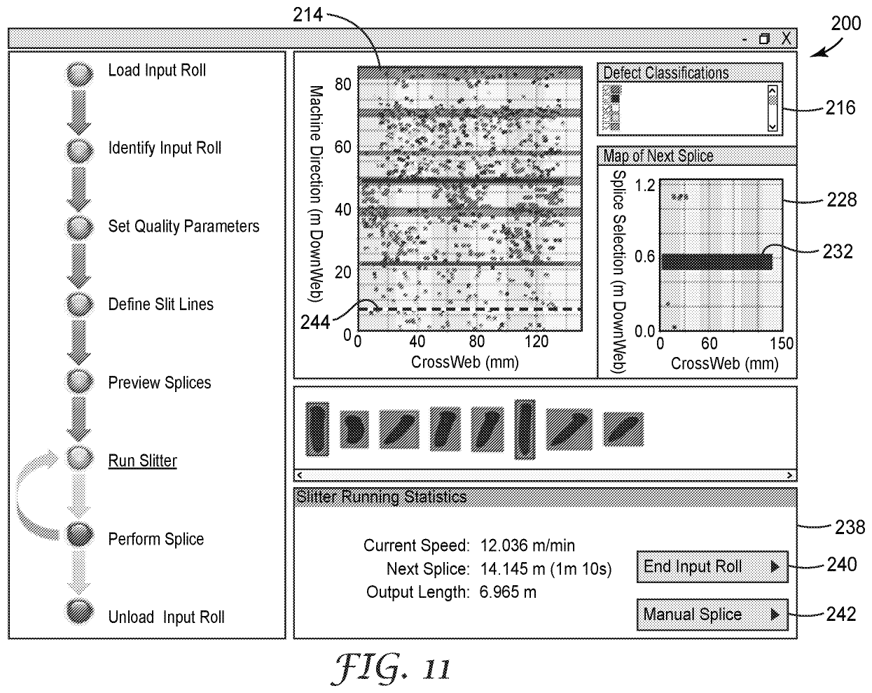

Returning to FIG. 5, slitter director 60 may then cause slitter 40 to perform the at least one splice (120). FIG. 11 is a conceptual diagram showing an example user interface of system monitor 80 for running slitter 40. Defect map 214 shows all the upcoming splices as well as a moving line 244. Moving line 244 moves as a function of the incoming web speed. During the run slitter phase, system monitor 80 will continue to display splice map 228 which shows a zoomed-in map of the upcoming splice as well splice defect images.

As shown in FIG. 11, system monitor 80 may be configured to additionally display slitter running statistics 238. Slitter running statistics 238 may include information about the current operation of slitter 40, including the current speed of the slitter, the distance to the next recommend splice, and the total output length that has been processed. Note that the output length will often not match the position of moving line 244. This is because moving line 244 is an indicator of how far into the input roll the slitter has processed. The output length represents how much material has been wound at the knife. These distances will be different because the spliced-out material does not get included in the output length. System monitor 80 may also provide an end input roll button 240 for ending the current input web roll 20 as well as a manual splice button 242 that allows a user to manually enter a splice location.

When first starting, slitter director 60 may causes slitter 40 to run at a predefined slower slow speed (e.g., 30 m/min. (100 ft./min.)) that allows fiducial reader 44 to read fiducial marks 43. Slitter 60 may synchronize the system and register previously-generated anomaly data 62 once two fiducial marks are read. Slitter director 60 then calculates the remaining distance in web 20 before the next recommend splice. If the next recommended splice is more than a predefined slow down distance (e.g., 20 meters) away, slitter director 60 may increase the speed of slitter 40 to a production speed (e.g., a maximum speed of slitter 40 and/or a speed that is faster than fiducial reader 44 may read fiducial marks). If the next recommended splice is less than the predefined slow down distance, slitter director 60 will cause slitter 40 to maintain at the slower speed so that fiducial reader 44 may continually register physical locations of web 20 with previously-generated anomaly data 62 in order to maintain accuracy.

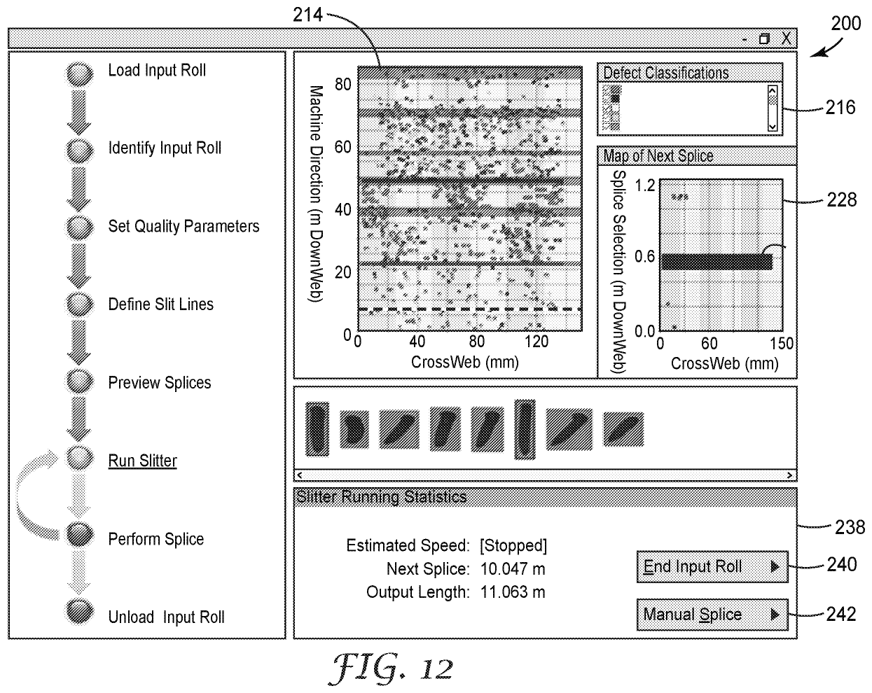

FIG. 12 is a conceptual diagram showing another example user interface of system monitor 80 for running slitter 40. FIG. 12 shows an example of output displayed in slitter running statistics 238 when the slitter is stopped. Slitter director 60 may cause slitter 40 to stop when the downweb position of web 20 reaches the position of a recommend splice. When the slitter is stopped, end input roll button 240 and manual splice button 242 become active.

As defective material that has been determined to be removed approaches the splice station of slitter 40, slitter director 60 cause slitter 40 to stop. Slitter director 60 may then cause fiducial reader 44 to scan the fiducial mark closest to the start of the section of material to be removed. Slitter director 60 may then cause slitter 40 to remove the defective material and splice together the web. Slitter director 60 may then cause fiducial reader 44 to scan the fiducial mark nearest the end of defective section. In some examples, after an expected splice recommend by slitter director 60, slitter director 60 may only cause fiducial reader 44 to read one fiducial mark (e.g., the first fiducial mark after the spliced section) in order to register the remaining web with previously-generated anomaly data 62.

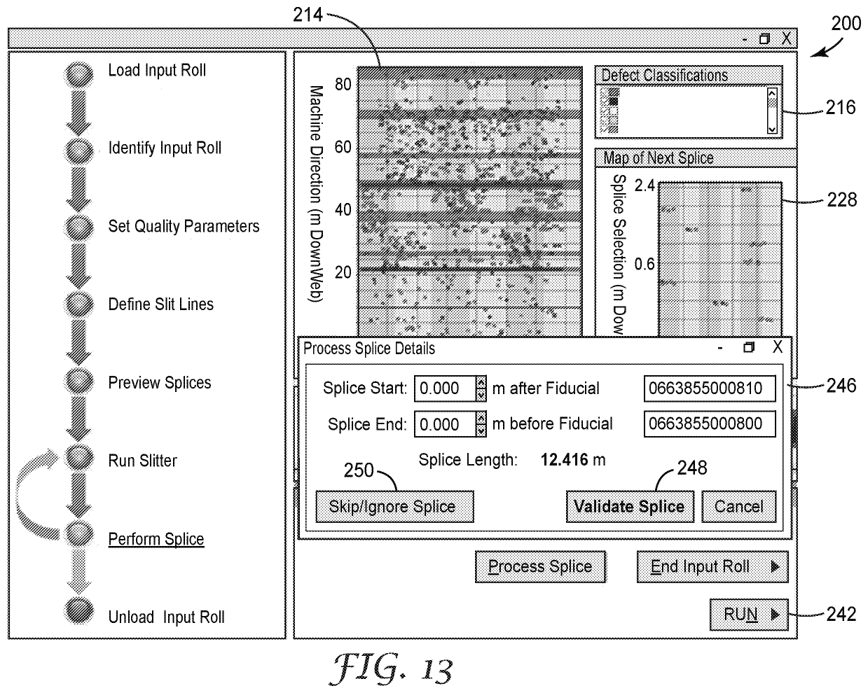

Slitter director 60 may also allow a user to input manual splices (e.g., any other splice that is not automatically calculated by slitter director 60). FIG. 13 is a conceptual diagram showing another example user interface of system monitor 80 for entering manual splices. After pressing manual splice button 242 (see FIG. 12), system monitor 80 may cause user interface 200 to display splice input box 246. A user may then enter data indicating how soon to start a splice after a particular fiducial mark and how soon to end the splice before another fiducial mark. Adjusting the splice start for the “after Fiducial” moves the start of the splice closer to the unwinding roll. Adjusting the splice end for the “before Fiducial” moves the end of the splice closer to the winder (slit knives). Based on the data input by the user, splice input box 246 may display the length of the manual splice. If the user wants to proceed with the manually entered splice, the user may select validate splice button 248. If the user wants to skip the splice, the user may select skip/ignore splice button 250. If the splice has been validated, the user may select run button 252. Slitter director 60 may then cause slitter 40 to perform the manual splice. After a manual splice, slitter director 60 may return to a startup mode at the slow speed, as described above. When a manual splice is added or an expected splice is modified, slitter director 60 may recalculate the position of the remaining splices determined by slitter director 60.

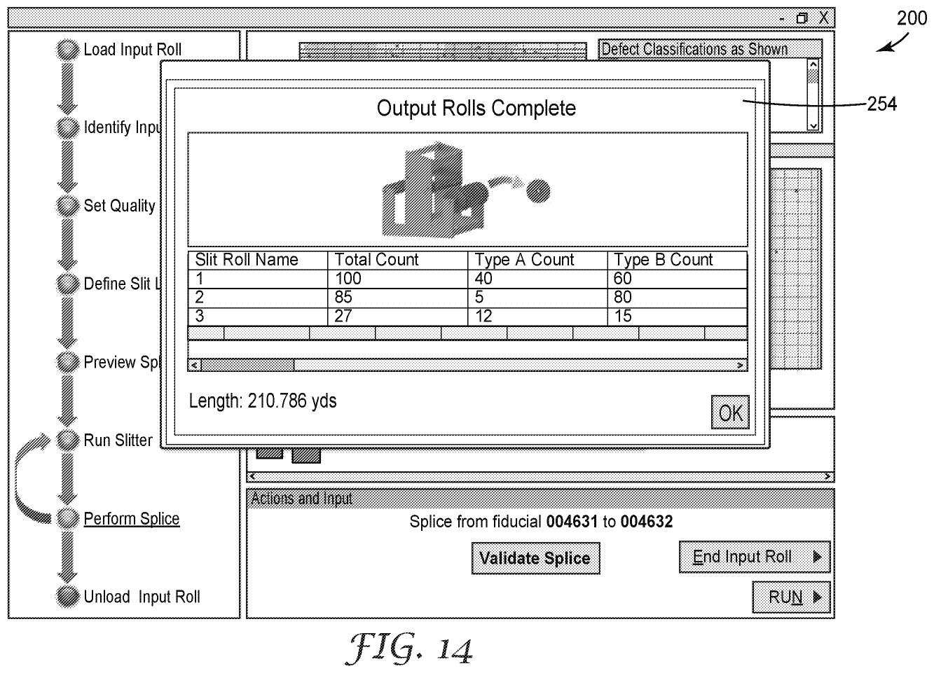

Returning to FIG. 5, after the input roll is processed, or after the desired amount of materials in the output slit rolls has been achieved, slitter director 60 may instruct the user to output the slit rolls (122). FIG. 14 is a conceptual diagram showing an example user interface of system monitor 80 for outputting the slit rolls. System monitor 80 may display user interface 80 include slit roll information box 254. Slitter director 60 may prompt the user to enter output slit roll information, including naming each roll.

Returning to FIG. 5, slitter director may then generate and store registered data anomaly maps for each of the output slit rolls (124). The registered data anomaly maps may include registered anomaly data that is present for each of the output slit rolls. The registered data anomaly maps may also include information indicating the location of each splice performed on the output slit roll. The registered data anomaly maps may further include information indicating the source of the original input web rolls as well as links and/or pointers to the previously-generated anomaly data 62 used by slitter director 60 to automatically process the input web rolls in the output slit rolls.

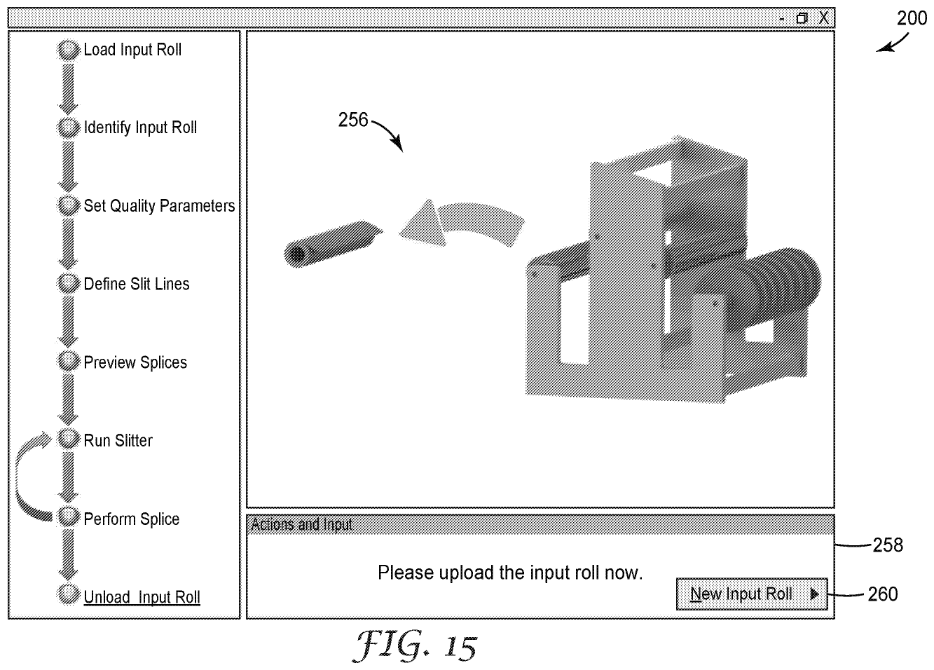

After the output slit rolls are completed, slitter director 60 may instruct the user to unload the input roll (126). FIG. 15 is a conceptual diagram showing an example user interface of system monitor 80 for unloading the input roll. In the example of FIG. 15, user interface 200 may display a graphic 256 or text box 258 that instructs the user to unload the input roll. User interface 200 may further include a new input roll button 260. When the user selects new input roll button 260, slitter director 60 will return to the original load input roll process (e.g., FIG. 6).

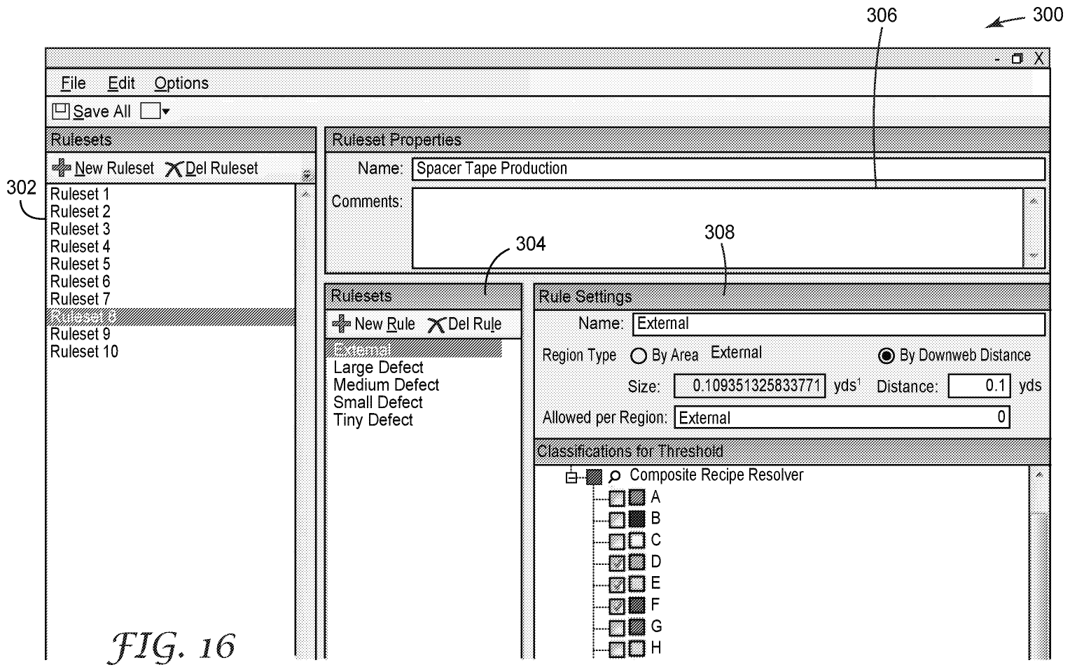

As described above, slitter director 60 may include ruleset manager 82 that allows a user to select rulesets and configure at least one rule and at least one condition in the ruleset that slitter director 60 uses to automatically convert web 20 into output slit rolls. FIG. 16 shows an example of a user interface 300 of ruleset manager 82. In some examples, slitter director 60 may access the rulesets from a server. In other examples, the rulesets may be stored in memory 76 of slitter controller 70 (see FIG. 4). In general, a ruleset may include a name, a comments section, and at least one rule and at least one condition. Each rule may include a name, a type, a size (area or length) condition, a count condition, and a list of defect classifications.

Rulesets window 302 allows a user to select a particular ruleset from among multiple rulesets. A user may also delete a selected ruleset or create a new ruleset. When a particular ruleset is selected, a user may name the ruleset and enter comments in ruleset properties window 306.

Rules window 304 shows the rules that are configured for the selected ruleset from rulesets window 302. A user may also delete a selected rule or create a new rule. When a particular rule is selected, a user may name the rule and configure thresholds for defect classifications in rule settings window 308.

Ruleset manager 82 allows a user to set rule settings as a function of area, as a function of downweb distance, or both. If the rule uses an area region type, then the downweb distance that is included in the calculation will be determined based on the slit lane width. For example, if the rule is 1 square meter and a slit lane is 100 mm wide, then the downweb sampling size will be 1 square meter/0.1 meter=10 meters. If the rule uses a downweb distance, then the downweb distance is honored regardless of the slit lane width. For example, if the rule is 1 m then slitter director 60 will sample 1 m downweb if the slit lane width is 100 mm or 1000 mm.

Ruleset manger 82 also allows a user to configure the number of allowed defects per classification type before a particular section of web is spliced out (“Allowed per Region”). For example, if the user sets the “Allowed per Region” for a particular selected defect classification to five, then slitter director 60 will not spice the web if the defined section has up to, but no more than, five of the selected defects. If the defined section has more than five of the selected defect classification, slitter director 60 will automatically cause slitter 60 to remove that section of the web.

As can be seen in FIG. 16, ruleset manager 82 allows a user to define multiple rules in a ruleset, where each rule can have multiple conditions. In the example of FIG. 16, the selected ruleset includes five different rules, and each of the five rules may be defined by multiple different conditions based on the different defect classification types. Having multiple rules allows the user to have different sampling sizes, different counts (“Allowed per Region”), and different classifications. If any one of the rules is exceeded, then slitter director 60 causes slitter 40 to splice the section.

As discussed above, slitter director 60 may be configured to monitor the operation of slitter 40 and provide system recovery operations as well as user warning and errors. In one example, slitter director 60 may be configured to save all data related to the processing of an output slit roll to a file. If system monitor 80 were to close unexpectedly or if there is material between the splice station and the slitting knives when slitter director 60 closes, then the data for that material is also stored. The next time system monitor 80 is launched, system monitor 80 may prompt the user to decide whether to use that stored data.

System monitor 80 may be configured to receive scanned fiducial readings from fiducial reader 44 and may determine which direction system monitor 80 expects fiducials to be read (e.g., incrementing or decrementing). The determination may be based on the relative position of the fiducial mark in the input roll data. Whichever direction has more material is the direction that is expected. For instance, if there are fiducial marks 1-1000 on a roll, and fiducial 250 is scanned, then slitter director 60 may make the initial assumption that the fiducial marks are ascending. If, when slitter 40 starts running, the fiducial marks come in reverse order, then slitter 60 may stop slitter 40 and may present a dialog to the user. The dialog allows the user to flip the data downweb and return the user to the identify input roll screen (e.g., FIG. 6). Slitter director 60 may also be configured to provide error and/or confirmation messages to user in the case of a skipped splice (e.g., the user manually skips a splice) or a missed splice (e.g., slitter director 60 fails to stop slitter 40 before the next recommend splice).

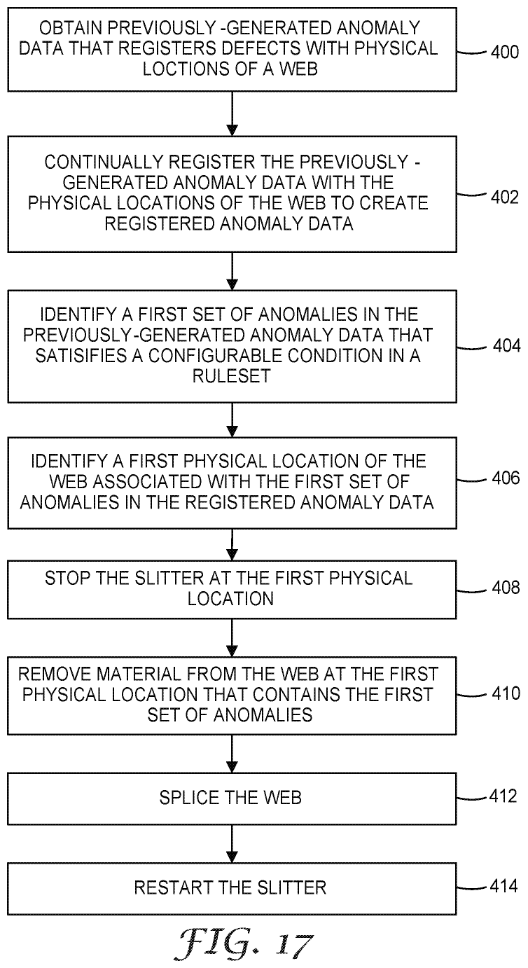

FIG. 17 is a flowchart illustrating an example operation of slitter director 60 in accordance with one example of the disclosure. Slitter director 60 obtains previously-generated anomaly data 62 that registers defects with a physical location of web 20 (400). As one example, slitter director 60 may obtain previously-generated anomaly data 62 from a database. Slitter director 60 may cause slitter 40 to start processing web 20 into output slit rolls. As part of the processing, slitter director 60 may continually register the previously-generated anomaly data with the physical locations of web 20 to create registered anomaly data 63 (402). In some examples, slitter director 60 may only continually register the previously-generated anomaly data 62 when an area of web 20 to be spliced is within a predetermined threshold distance of the splicing station of slitter 40.

Slitter director 60 may identify a first set of anomalies in previously-generated anomaly data 62 that satisfies a configured condition in a ruleset (404). The ruleset specifies at least one condition indicating when the defects are to be removed from web 20. Slitter director 60 stops slitter 40 when web 20 reaches the first physical location (408). Once the slitter 40 is stopped, slitter director 60 may cause slitter 40 to remove material form web 20 at the first physical location that contains the first set of anomalies (410). Slitter director 60 may then cause slitter 40 to splice the web (412) and may then restart the slitter (414).

Although discussed with respect to specific embodiments, those having skill in the art will recognize other embodiments that do not depart from the techniques described herein. Therefore, the claims should not be limited to those specific embodiments described herein. For example, although many embodiments are described with respect to making a mark to indicate those products for which an anomaly may cause a defect, in another embodiment, the system may make a mark to indicate which products may safely be manufactured from the anomalous region of the web.

### Exemplary Embodiments

1A. A method comprising:

obtaining previously-generated anomaly data that registers defects with physical locations of a web;

continually registering the previously-generated anomaly data with the physical locations of the web to create registered anomaly data;

automatically controlling a slitter to convert the web into a plurality of slit rolls in accordance with the registered anomaly data and a ruleset that specifies at least one condition indicating when the defects are to be removed from the web; and

generating and storing registered anomaly data maps for each of the plurality of slit rolls.

2A. The method of Exemplary Embodiment 1A, wherein automatically converting the web into a plurality of slit rolls comprises:

identifying a first set of anomalies in the previously-generated anomaly data that satisfies a configurable condition in the ruleset;

identifying a first physical location of the web associated with the first set of anomalies in the registered anomaly data;

stopping the slitter at the first physical location;

removing material from the web at the first physical location that contains the first set of anomalies;

splicing the web; and

restarting the slitter.

3A. The method of Exemplary Embodiment 2A, further comprising manually adding a splice to the web.
4A. The method of either Exemplary Embodiment 2A or 3A, further comprising selectively disabling removing material from the web at the first physical location that contains the first set of anomalies.
5A. The method of any of Exemplary Embodiments 1A to 4A, wherein automatically converting the web into a plurality of slit rolls comprises:

identifying at least one defective slit roll from the plurality of slit rolls based on registered anomaly data; and

rejecting the defective slit rolls.

6A. The method of any of Exemplary Embodiments 1A to 5A, wherein the registered anomaly data maps include at least one of defect location from the registered anomaly data, splice locations, or changes of the web roll.
7A. The method of any of Exemplary Embodiments 1A to 6A, wherein obtaining the previously-generated anomaly data associated with the web comprises obtaining the previously-generated anomaly data associated with the web from a separate manufacturing line configured to manufacture the web.
8A. The method of any of Exemplary Embodiments 1A to 7A, wherein obtaining the previously-generated anomaly data associated with the web comprising combining anomaly data from at least one manufacturing line to create the previously-generated anomaly data.
9A. The method of any of Exemplary Embodiments 1A to 8A, wherein obtaining the previously-generated anomaly data associated with the web comprises obtaining the previously-generated anomaly data associated with the web from an in-line manufacturing line configured to manufacture the web, wherein the in-line web manufacturing line includes a web manufacturing system configured to manufacture the web and the slitter.
10A. The method of any of Exemplary Embodiments 1A to 9A, further comprising determining a width of slit lanes of the slitter based on the previously-generated anomaly data.
11A. The method of Exemplary Embodiment 10A, further comprising determining the ruleset and the width of the slit lanes based on the previously-generated anomaly data.
12A. The method of any of Exemplary Embodiments 1A to 11A, further comprising configuring the ruleset.
13A. The method of Exemplary Embodiment 12A, wherein the ruleset includes a combination of conditions.
14A. The method of Exemplary Embodiment 12A, wherein the ruleset is independent for each of the plurality of slit rolls.
15A. The method of any of Exemplary Embodiments 1A to 14A, further comprising:

detecting errors in the operation of the slitter; and

displaying messages indicating the errors to a user.

16A. The method of any of Exemplary Embodiments 1A to 15A, wherein continually registering the previously-generated anomaly data with physical locations of the web to create registered anomaly data comprises;

aligning the previously-generated anomaly data to a coordinate system of the slitter to create aligned anomaly data; and

continually registering the aligned anomaly data with physical locations of the web to create registered anomaly data.

17A. The method of Exemplary Embodiment 16A, wherein aligning the previously-generated anomaly data to a coordinate system of the slitter to create aligned anomaly data comprises:

determining that the previously-generated anomaly data is not aligned to the coordinate system of the slitter;

altering the orientation of the previously-generated anomaly data to create aligned anomaly data; and

displaying the aligned anomaly data.

18A. The method of any of Exemplary Embodiments 1A to 17A, further comprising:

selectively disabling the continual registering of the previously-generated anomaly data with physical locations of the web to create registered anomaly data;

providing an indication of a physical location on the web to remove defects from the web based on the previously-generated anomaly data;

manually removing the defects at the physical location; and

manually splicing the web.

19A. The method of any of Exemplary Embodiments 1A to 18A, further comprising:

controlling a speed of the slitter based on the previously-generated anomaly data and the ruleset.

20A. The method of Exemplary Embodiment 19A, wherein controlling the speed of the slitter comprises:

running the slitter at a first speed in the case that the previously-generated anomaly data shows no rejectable defects within a predetermined distance to a splicing station of the slitter, wherein the predetermined distance is defined by the ruleset;

running the slitter at a second speed in the case that the previously-generated anomaly data shows rejectable defects within the predetermined distance to the splicing station of a slitter, wherein the second speed is slower than the first speed; and

continually registering the previously-generated anomaly data with physical locations of the web to create registered anomaly data only when the slitter is running at the second speed.

1B. A system comprising:

a database configured to store previously-generated anomaly data that registers defects with physical locations of a web;

a fiducial reader configured to read fiducial marks on the web, the fiducial marks indicating the physical locations of the web;

a slitter configured to convert the web into a plurality of slit rolls; and

at least one processor configured to control the operation of the slitter, the at least one processor configured to:
continually register the previously-generated anomaly data with the physical locations of the web to create registered anomaly data;
automatically control the slitter to convert the web into the plurality of slit rolls in accordance with the registered anomaly data and a ruleset that specifies at least one condition indicating when the defects are to be removed from the web; and
generate and store registered anomaly data maps for each of the plurality of slit rolls.
   2B. The system of Exemplary Embodiment 1B, wherein to automatically convert the web into a plurality of slit rolls, the at least one processor is further configured to:

identify a first set of anomalies in the previously-generated anomaly data that satisfies a configurable condition in the ruleset;

identify a first physical location of the web associated with the first set of anomalies in the registered anomaly data;

stop the slitter at the first physical location;

cause the slitter to remove material from the web at the first physical location that contains the first set of anomalies;

cause the slitter to splice the web; and

restart the slitter.

3B. The system of Exemplary Embodiment 2B, further comprising a user interface in communication with the at least one processor, wherein the user interface includes an input for manually adding a splice to the web.
4B. The system of either Exemplary Embodiment 2B or 3B, further comprising:

a user interface in communication with the at least one processor, wherein the user interface includes an input for selectively disabling removing material from the web at the first physical location that contains the first set of anomalies.

5B. The system of any of Exemplary Embodiments 1B to 4B, wherein to automatically convert the web into a plurality of slit rolls, the at least one processor is further configured to:

identify at least one defective slit roll from the plurality of slit rolls based on registered anomaly data; and

reject the defective slit rolls.

6B. The system of any of Exemplary Embodiments 1B to 5B, wherein the registered anomaly data maps include at least one of defect location from the registered anomaly data, splice location, or change of the web roll.
7B. The system of any of Exemplary Embodiments 1B to 6B, wherein the database is further configured to obtain the previously-generated anomaly data associated with the web from a separate manufacturing line configured to manufacture the web.
8B. The system of any of Exemplary Embodiments 1B to 7B, wherein the database is further configured to obtain the previously-generated anomaly data associated by combining anomaly data from at least one manufacturing line to create the previously-generated anomaly data.
9B. The system of any of Exemplary Embodiments 1B to 8B, wherein the database is further configured to obtain the previously-generated anomaly data associated with the web from an in-line manufacturing line configured to manufacture the web, wherein the in-line web manufacturing line includes a web manufacturing system configured to manufacture the web and the slitter.
10B. The system of any of Exemplary Embodiments 1B to 9B, wherein the at least one processor is further configured to determine a width of slit lanes of the slitter based on the previously-generated anomaly data.
11B. The system of Exemplary Embodiment 10B, wherein the at least one processor is further configured to determine the ruleset and the width of the slit lanes based on the previously-generated anomaly data.
12B. The system of any of Exemplary Embodiments 1B to 11B, further comprising a user interface in communication with the at least one processor, wherein the user interface includes an input for configuring the ruleset.
13B. The system of Exemplary Embodiment 12B, wherein the ruleset includes a combination of conditions.
14B. The system of Exemplary Embodiment 12B, wherein the ruleset is independent for each of the plurality of slit rolls.
15B. The system of any of Exemplary Embodiments 1B to 14B, wherein the at least one processor is further configured to:

detect errors in the operation of the slitter; and

display messages indicating the errors to a user.

16B. The system of any of Exemplary Embodiments 1B to 15B, wherein to continually register the previously-generated anomaly data with physical locations of the web to create registered anomaly data, the at least one processor is further configured to:

align the previously-generated anomaly data to a coordinate system of the slitter to create aligned anomaly data; and

continually register the aligned anomaly data with physical locations of the web to create registered anomaly data.

17B. The system of Exemplary Embodiment 16B, wherein aligning the previously-generated anomaly data to a coordinate system of the slitter to create aligned anomaly data, the at least one processor is further configured to:

determine that the previously-generated anomaly data is not aligned to the coordinate system of the slitter;

alter the orientation of the previously-generated anomaly data to create aligned anomaly data; and

display the aligned anomaly data.

18B. The system of any of Exemplary Embodiments 1B to 17B, further comprising:

a user interface in communication with the at least one processor, wherein the user interface includes an input for selectively disabling the continual registering of the previously-generated anomaly data with physical locations of the web to create registered anomaly, and

wherein the at least one processor is further configured to provide an indication of a physical location on the web to remove defects from the web based on the previously-generated anomaly data, such that a user may manually remove the defects at the physical location and manually splice the web.

19B. The system of any of Exemplary Embodiments 1B to 18B, wherein the at least one processor is further configured to control a speed of the slitter based on the previously-generated anomaly data and the ruleset.
20B. The system of Exemplary Embodiment 19B, wherein to control the speed of the slitter, the at least one processor is further configured to:

run the slitter at a first speed in the case that the previously-generated anomaly data shows no rejectable defects within a predetermined distance to a splicing station of the slitter, wherein the predetermined distance is defined by the ruleset;

run the slitter at a second speed in the case that the previously-generated anomaly data shows rejectable defects within the predetermined distance to the splicing station of a slitter, wherein the second speed is slower than the first speed; and

continually register the previously-generated anomaly data with physical locations of the web to create registered anomaly data only when the slitter is running at the second speed.

1C. A non-transitory computer-readable storage medium storing instructions that, when executed, cause the at least one processor:

to obtain previously-generated anomaly data that registers defects with physical locations of a web;

to continually register the previously-generated anomaly data with the physical locations of the web to create registered anomaly data;

to automatically control a slitter to convert the web into a plurality of slit rolls in accordance with the registered anomaly data and a ruleset that specifies at least one condition indicating when the defects are to be removed from the web; or

to generate and store registered anomaly data maps for each of the plurality of slit rolls.

1D. A method comprising:

obtaining previously-generated anomaly data that registers defects with physical locations of a web;

determining at least one slit lane width based on the previously-generated anomaly data; and

automatically controlling a slitter to convert the web into a plurality of slit rolls in accordance with the determined at least one slit lane width.

2D. The method of Exemplary Embodiment 1D, further comprising identifying at least one defective slit roll from the plurality of slit rolls based on the previously-generated anomaly data and the determined at least one slit lane width.
3D. The method of either Exemplary Embodiment 1D or 2D, wherein determining the at least one slit lane width further comprises determining the at least one slit lane width based on the previously-generated anomaly data, output product type, and a ruleset that specifies an allowable number of defects in a slit roll of the plurality of slit rolls.
4D. The method of any of Exemplary Embodiments 1D to 3D, wherein automatically controlling the slitter further comprises automatically controlling a slitter to convert the web into a plurality of slit rolls in accordance with the determined at least one slit lane width, the previously-generated anomaly data, and the ruleset.
1E. A system comprising:

a database configured to store previously-generated anomaly data that registers defects with physical locations of a web;

a slitter configured to convert the web into a plurality of slit rolls; and

at least one processor configured to control the operation of the slitter, the at least one processor configured to:
obtain the previously-generated anomaly data that registers defects with physical locations of a web;
determine at least one slit lane width based on the previously-generated anomaly data; and
automatically control the slitter to convert the web into a plurality of slit rolls in accordance with the determined at least one slit lane width.
   2E. The system of Exemplary Embodiment 1E, wherein the at least one processor is further configured to identify at least one defective slit roll from the plurality of slit rolls based on the previously-generated anomaly data and the determined at least one slit lane width.
   3E. The system of either Exemplary Embodiment 1E or 2E, wherein to determine the at least one slit lane width, the at least one processor is further configured to determine the at least one slit lane width based on the previously-generated anomaly data, output product type, and a ruleset that specifies an allowable number of defects in a slit roll of the plurality of slit rolls.
   4E. The system of any of Exemplary Embodiments 1E to 3E, wherein to automatically control the slitter, the at least one processor is further configured to automatically control the slitter to convert the web into a plurality of slit rolls in accordance with the determined at least one slit lane width, the previously-generated anomaly data, and the ruleset that specifies an allowable number of defects in a slit roll of the plurality of slit rolls.
   1F. A non-transitory computer-readable storage medium storing instructions that, when executed, cause the at least one processor to:

obtain previously-generated anomaly data that registers defects with physical locations of a web;

determine at least one slit lane width based on the previously-generated anomaly data; and

automatically control a slitter to convert the web into a plurality of slit rolls in accordance with the determined at least one slit lane width.

1G. A method comprising:

obtaining previously-generated anomaly data that registers defects with physical locations of a web; and

identifying at least one defective slit roll from a plurality of slit rolls that are processed from the web based on the previously-generated anomaly data.

1H. A system comprising:

a database configured to store previously-generated anomaly data that registers defects with physical locations of a web;

a slitter configured to convert the web into a plurality of slit rolls; and

at least one processor configured to control the operation of the slitter, the at least one processor configured to:
obtain previously-generated anomaly data that registers defects with physical locations of the web; and
identify at least one defective slit roll from the plurality of slit rolls based on the previously-generated anomaly data.
   11. A non-transitory computer-readable storage medium storing instructions that, when executed, cause the at least one processor to:

obtain previously-generated anomaly data that registers defects with physical locations of a web; and

identify at least one defective slit roll from a plurality of slit rolls that are processed from the web based on the previously-generated anomaly data.

Foreseeable modifications and alterations of this disclosure will be apparent to those skilled in the art without departing from the scope and spirit of this invention. This invention should not be restricted to the embodiments that are set forth in this application for illustrative purposes.

1. A method comprising:
obtaining previously-generated anomaly data that registers defects with physical locations of a web;
continually registering the previously-generated anomaly data with the physical locations of the web to create registered anomaly data;
automatically controlling a slitter to convert the web into a plurality of slit rolls in accordance with the registered anomaly data and a ruleset that specifies at least one condition indicating when the defects are to be removed from the web; and
generating and storing registered anomaly data maps for each of the plurality of slit rolls.

2. The method of claim 1, wherein automatically converting the web into a plurality of slit rolls comprises:
identifying a first set of anomalies in the previously-generated anomaly data that satisfies a configurable condition in the ruleset;
identifying a first physical location of the web associated with the first set of anomalies in the registered anomaly data;
stopping the slitter at the first physical location;
removing material from the web at the first physical location that contains the first set of anomalies;
splicing the web; and
restarting the slitter.

3. The method of claim 2, further comprising manually adding a splice to the web.

4. The method of claim 2, further comprising selectively disabling removing material from the web at the first physical location that contains the first set of anomalies.

5. The method of claim 1, wherein automatically converting the web into a plurality of slit rolls comprises:
identifying at least one defective slit roll from the plurality of slit rolls based on registered anomaly data; and
rejecting the defective slit rolls.

6. The method of claim 1, further comprising determining a width of slit lanes of the slitter based on the previously-generated anomaly data.

7. The method of claim 6, further comprising:
determining the ruleset and the width of the slit lanes based on the previously-generated anomaly data.

8. The method of claim 1, wherein the ruleset is independent for each of the plurality of slit rolls.

9. The method of claim 1, wherein continually registering the previously-generated anomaly data with physical locations of the web to create registered anomaly data comprises:
aligning the previously-generated anomaly data to a coordinate system of the slitter to create aligned anomaly data; and
continually registering the aligned anomaly data with physical locations of the web to create registered anomaly data.

10. The method of claim 1, further comprising:
controlling a speed of the slitter based on the previously-generated anomaly data and the ruleset, including:
running the slitter at a first speed in the case that the previously-generated anomaly data shows no rejectable defects within a predetermined distance to a splicing station of the slitter, wherein the predetermined distance is defined by the ruleset;
running the slitter at a second speed in the case that the previously-generated anomaly data shows rejectable defects within the predetermined distance to the splicing station of a slitter, wherein the second speed is slower than the first speed; and
continually registering the previously-generated anomaly data with physical locations of the web to create registered anomaly data only when the slitter is running at the second speed.

11. A system comprising:
a database configured to store previously-generated anomaly data that registers defects with physical locations of a web;
a fiducial reader configured to read fiducial marks on the web, the fiducial marks indicating the physical locations of the web;
a slitter configured to convert the web into a plurality of slit rolls; and
at least one processor configured to control the operation of the slitter, the at least one processor configured to:
continually register the previously-generated anomaly data with the physical locations of the web to create registered anomaly data;
automatically control the slitter to convert the web into the plurality of slit rolls in accordance with the registered anomaly data and a ruleset that specifies at least one condition indicating when the defects are to be removed from the web; and
generate and store registered anomaly data maps for each of the plurality of slit rolls.

12. The system of claim 11, wherein to automatically convert the web into a plurality of slit rolls, the at least one processor is further configured to:
identify a first set of anomalies in the previously-generated anomaly data that satisfies a configurable condition in the ruleset;
identify a first physical location of the web associated with the first set of anomalies in the registered anomaly data;
stop the slitter at the first physical location;
cause the slitter to remove material from the web at the first physical location that contains the first set of anomalies;
cause the slitter to splice the web; and
restart the slitter.

13. The system of claim 12, further comprising a user interface in communication with the at least one processor, wherein the user interface includes an input for manually adding a splice to the web.

14. The system of claim 12, further comprising:
a user interface in communication with the at least one processor, wherein the user interface includes an input for selectively disabling removing material from the web at the first physical location that contains the first set of anomalies.

15. The system of claim 11, wherein to automatically convert the web into a plurality of slit rolls, the at least one processor is further configured to:
identify at least one defective slit roll from the plurality of slit rolls based on registered anomaly data; and
reject the defective slit rolls.

16. The system of claim 11, wherein the at least one processor is further configured to determine a width of slit lanes of the slitter based on the previously-generated anomaly data.

17. The system of claim 16, wherein the at least one processor is further configured to determine the ruleset and the width of the slit lanes based on the previously-generated anomaly data.

18. The system of claim 11, wherein the ruleset is independent for each of the plurality of slit rolls.

19. The system of claim 11, wherein to continually register the previously-generated anomaly data with physical locations of the web to create registered anomaly data, the at least one processor is further configured to:
align the previously-generated anomaly data to a coordinate system of the slitter to create aligned anomaly data; and
continually register the aligned anomaly data with physical locations of the web to create registered anomaly data.

20. The system of claim 11, wherein the at least one processor is further configured to:
control a speed of the slitter based on the previously-generated anomaly data and the ruleset, wherein to control the speed of the slitter, the at least one processor is further configured to:
run the slitter at a first speed in the case that the previously-generated anomaly data shows no rejectable defects within a predetermined distance to a splicing station of the slitter, wherein the predetermined distance is defined by the ruleset;
run the slitter at a second speed in the case that the previously-generated anomaly data shows rejectable defects within the predetermined distance to the splicing station of a slitter, wherein the second speed is slower than the first speed; and
continually register the previously-generated anomaly data with physical locations of the web to create registered anomaly data only when the slitter is running at the second speed.
